(19) United States
(12) Patent Application Publication
(10) Pub. No.: US 2025/0305201 A1
(43) Pub. Date: Oct. 2, 2025

(54) WASHING MACHINE AND LIQUID LEVEL DETECTION DEVICE

(71) Applicant: SAMSUNG ELECTRONICS CO., LTD., Suwon-si (KR)

(72) Inventors: Euihyun JUNG, Suwon-si (KR); Taegyu KIM, Suwon-si (KR); Minwoo RYU, Suwon-si (KR); Jungwook BAE, Suwon-si (KR); Gwangjin JUNG, Suwon-si (KR); Jihoon HA, Suwon-si (KR)

(73) Assignee: SAMSUNG ELECTRONICS CO., LTD., Suwon-si (KR)

(21) Appl. No.: 19/063,799

(22) Filed: Feb. 26, 2025

Related U.S. Application Data
(63) Continuation of application No. PCT/KR2025/002118, filed on Feb. 13, 2025.

(30) Foreign Application Priority Data
Mar. 29, 2024 (KR) 10-2024-0043775

(51) Int. Cl. D06F 34/14; D06F 23/02; D06F 34/32; D06F 39/02; D06F 103/00; D06F 105/58; G01F 23/72

(52) U.S. Cl. CPC D06F 34/14; D06F 23/02; D06F 34/32; D06F 39/022; G01F 23/72; D06F 2103/00; D06F 2105/58

(57) ABSTRACT

A washing machine may include: a tub; a detergent box configured to store liquid detergent to be supplied to the tub; a magnet generating a magnet field; a floating case in the detergent box and configured to move vertically in the detergent box depending on a height of the liquid detergent stored in the detergent box, the floating case configured to support the magnet; a magnetic field sensor at a side of the floating case and configured to detect the magnetic field generated by the magnet and output an electrical signal indicative of an amount of the liquid detergent stored in the detergent box based on the detected magnetic field; and a user interface configured to output information on the amount of the liquid detergent stored in the detergent box based on the electrical signal output from the magnetic field sensor.

### CROSS-REFERENCE TO RELATED APPLICATIONS

This is a continuation application, under 35 U.S.C. § 111 (a), of International Application No. PCT/KR2025/002118, filed Feb. 13, 2025, which claims priority under 35 U.S.C. § 119 to Korean Patent Application No. 10-2024-0043775, filed Mar. 29, 2024, in the Korean Intellectual Property Office, the disclosures of which are incorporated herein in their entireties by reference.

### TECHNICAL FIELD

The present disclosure relates to a washing machine including a detergent amount detection device, and a liquid level detection device.

### BACKGROUND ART

A washing machine is a device that uses a driving force of a motor to agitate together laundry, washing water, and detergent which are input to a drum, thereby washing the laundry through friction therebetween.

The washing machine includes a main body forming an exterior and a detergent supply device disposed within the main body. The detergent supply device is a device that allows detergent to be evenly mixed with the supplied water and to be supplied together during a process of supplying water into a tub of the washing machine.

The detergent supply device may include a detergent box provided to store detergent, and a detergent pump configured to pump the detergent stored in the detergent box. The detergent box may store powdered detergent, liquid detergent, fabric softener, etc. The liquid detergent or fabric softener stored in the detergent box may be moved into the inside of the detergent pump, and then discharged out of the outside of the detergent pump to move to the tub together with the washing water.

### DISCLOSURE

### Technical Problem

One aspect of the present disclosure provides a washing machine and a liquid level detection device including an improved structure capable of efficiently detecting a remaining amount of liquid detergent, and the like in a detergent box.

One aspect of the present disclosure provides a washing machine and a liquid level detection device including an improved structure capable of preventing a floating device for detecting a remaining amount of liquid detergent, and the like in a detergent box from being stuck to a bottom surface of the detergent box.

One aspect of the present disclosure provides a washing machine and a liquid level detection device including an improved structure capable of preventing liquid detergent, etc. from remaining on an upper portion of a floating device for detecting a remaining amount of liquid detergent, and the like in a detergent box.

One aspect of the present disclosure provides a washing machine and a liquid level detection device including an improved structure capable of guiding the rise and fall of a floating device for detecting a remaining amount of liquid detergent, and the like in a detergent box.

One aspect of the present disclosure provides a washing machine and a liquid level detection device including an improved structure capable of checking whether a floating device for detecting a remaining amount of liquid detergent, and the like in a detergent box is stuck to a bottom surface of a detergent box.

The technical objectives of the present invention are not limited to the above, and other objectives that are not described above may become apparent to those of ordinary skill in the art based on the following descriptions.

### Technical Solution

In accordance with the present disclosure, a washing machine may include: a tub; a detergent box configured to store liquid detergent to be supplied to the tub; a magnet generating a magnet field; a floating case in the detergent box and configured to move vertically in the detergent box depending on a height of the liquid detergent stored in the detergent box, the floating case configured to support the magnet; a magnetic field sensor at a side of the floating case and configured to detect the magnetic field generated by the magnet and output an electrical signal indicative of an amount of the liquid detergent stored in the detergent box based on the detected magnetic field; and a user interface configured to output information on the amount of the liquid detergent stored in the detergent box based on the electrical signal output from the magnetic field sensor.

The user interface may include a display configured to display the information.

The floating case may include: a base supporting the magnet, and a leg extending from the base toward a bottom surface of the detergent box so that, with a vertical position of the floating case being at a lowest position in the detergent box, the leg is supported on the bottom surface of the detergent box.

A horizontal area of the leg may be less than a horizontal area of the base.

A lower end of the leg that contacts the bottom surface of the detergent box when the vertical position of the floating case is at the lowest position may have a horizontal width that is less than a horizontal width of an upper end of the leg that is adjacent to the base.

At least a portion of the leg may have a horizontal area that decreases as a distance of the leg away from the base increases.

The floating case may include: a base supporting the magnet, and a cover covering an upper side of the magnet, and an upper surface of the cover may include an inclined portion extending from an upper end of the cover toward the base and inclined with respect to a horizontal direction.

The inclined portion may include a conical portion having a horizontal width that decreases as a distance from the upper end of the cover decreases.

The inclined portion may include a curved portion between the conical portion and the base and having an inclination angle with respect to the horizontal direction that increases as a distance from the base decreases.

The detergent box may include a guide rib along a periphery of the floating case configured to guide movement in a vertical direction of the floating case in the detergent box.

The guide rib may extend upward from a bottom surface of the detergent box.

The guide rib may include a plurality of guide ribs, the plurality of guide ribs may form a movement space in which the floating case is movable in the vertical direction, and the detergent box may further include a cap covering an upper side of the movement space and coupled to an upper end of each guide rib of the plurality of guide ribs.

The guide rib may include a support portion protruding from a lower portion of the guide rib and configured so that, with a vertical position of the floating case being at a lowest position in the detergent box, a lower portion of the floating case is supported on the lower portion of the guide rib and the floating case is spaced apart from a bottom surface of the detergent box.

The washing machine may further include: a detergent detection electrode configured to detect a height of the liquid detergent stored in the detergent box; and at least one controller electrically connected to the detergent detection electrode and configured to receive the electrical signal from the magnetic field sensor, and the at least one controller is configured to: based on the height of the liquid detergent detected by the detergent detection electrode being greater than or equal to a predetermined height and a height of the liquid detergent based on the amount of the liquid detergent indicated by the electrical signal received from the magnetic field sensor being less than the predetermined height, determine that the floating case is stuck to the detergent box.

The at least one controller may be further configured to, based on the determination that the floating case is stuck to the detergent box, control the user interface to output information on the floating case being stuck to the detergent box.

According to an embodiment of the present disclosure, a washing machine may include: a tub; a detergent box provided to store liquid detergent to be supplied to the tub; a floating device disposed in the detergent box, configured to move between a bottom position closest to a bottom surface of the detergent box and a floating position rising from the bottom position by the buoyancy due to liquid detergent in the detergent box, the floating device including a magnet; a magnetic field sensor disposed below the floating device and configured to detect a magnetic field by the magnet; and a display configured to display information on a remaining amount of the liquid detergent in the detergent box based on an electrical signal output from the magnetic field sensor.

According to an embodiment of the present disclosure, a liquid level detection device may include: a floating case configured to move vertically in a liquid container depending on a height of liquid contained in the liquid container and provided to support a magnet; a magnetic field sensor disposed on one side of the floating case and configured to detect a magnetic field by the magnet; and a user interface configured to output information on a remaining amount of the liquid stored in the liquid container based on an electrical signal output from the magnetic field sensor.

### DESCRIPTION OF DRAWINGS

FIG. 1 is a perspective view illustrating a washing machine according to one embodiment of the present disclosure.

FIG. 2 is a cross-sectional view of the washing machine according to one embodiment of the present disclosure.

FIG. 3 is a view illustrating a detergent supply device of the washing machine according to one embodiment of the present disclosure.

FIG. 4 is a top view of some components separated from the detergent supply device of the washing machine according to one embodiment of the present disclosure.

FIG. 5 is a cross-sectional view of the detergent supply device of the washing machine according to one embodiment of the present disclosure.

FIG. 6 is a view illustrating some components of the detergent supply device, such as a detergent box and a floating device, of the washing machine according to one embodiment of the present disclosure.

FIG. 7 is an enlarged view of some components, such as the detergent box, the floating device, and a magnetic field sensor, in the detergent supply device of the washing machine according to one embodiment of the present disclosure when the floating device is at a bottom position.

FIG. 8 is an enlarged view of some components, such as the detergent box, the floating device, and the magnetic field sensor, in the detergent supply device of the washing machine according to one embodiment of the present disclosure when the floating device is at a floating position.

FIG. 9 is a perspective view illustrating the floating device of the detergent supply device of the washing machine according to one embodiment of the present disclosure.

FIG. 10 is a bottom perspective view illustrating the floating device of the detergent supply device of the washing machine according to one embodiment of the present disclosure.

FIG. 11 is an exploded view of the floating device of the detergent supply device of the washing machine according to one embodiment of the present disclosure.

FIG. 12 is a cross-sectional view of the floating device of the detergent supply device of the washing machine according to one embodiment of the present disclosure.

FIG. 13 is an enlarged view of part B of FIG. 12.

FIG. 14 is an enlarged view of part A of FIG. 10.

FIG. 15 is a view illustrating a floating device of a detergent supply device of a washing machine according to one embodiment of the present disclosure.

FIG. 16 is an enlarged view of some components, such as a detergent box including a guide rib, a floating device, and a magnetic field sensor, in a detergent supply device of a washing machine according to one embodiment of the present disclosure.

FIG. 17 is a block diagram illustrating some components of the washing machine according to one embodiment of the present disclosure.

FIG. 18 is a view illustrating the floating device that descends as an amount of detergent remaining in the detergent box included in the detergent supply device of the washing machine according to one embodiment of the present disclosure decreases.

FIG. 19 is a view illustrating an example of a state in which a display of the washing machine according to one embodiment of the present disclosure outputs information on an amount of detergent remaining in the detergent box detected by the floating device and the magnetic field sensor.

FIG. 20 is a view illustrating an example of a state in which the display of the washing machine according to one embodiment of the present disclosure outputs information on an amount of detergent remaining in the detergent box detected by the floating device and the magnetic field sensor as an amount of detergent remaining in the detergent box is reduced compared to the state of FIG. 19.

FIG. 21 is a view illustrating the detergent box, the floating device, and a detergent detection electrode of the detergent supply device of the washing machine according to one embodiment of the present disclosure.

FIG. 22 is a flowchart illustrating a method for determining whether the floating device is stuck to the detergent box using the floating device, the magnetic field sensor, and the detergent detection sensor of the detergent supply device of the washing machine according to one embodiment of the present disclosure.

FIG. 23 is a view illustrating an example of a state in which the display of the washing machine according to one embodiment of the present disclosure outputs information on the floating device being stuck to the detergent box.

### Modes of the Invention

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A washing machine according to various embodiments may perform washing, rinsing, spin-drying, and drying processes. The washing machine is an example of a clothes treating apparatus, and the clothes treating apparatus is a concept including a device capable of washing clothes (objects to be washed, and objects to be dried), a device capable of drying clothes, and a device capable of washing and drying clothes.

The washing machine according to various embodiments may include a top-loading washing machine in which a laundry inlet for inserting or removing laundry is provided to face upward, or a front-loading washing machine in which a laundry inlet is provided to face forward. The washing machine according to various embodiments may include a washing machine of a loading type other than the top-loading washing machine and the front-loading washing machine.

For the top-loading washing machine, laundry may be washed using water current generated by a rotating body such as a pulsator. For the front-loading washing machine, laundry may be washed by repeatedly lifting and lowering laundry by rotating a drum. The front-loading washing machine may include a dryer combined washing machine capable of drying laundry stored in a drum. The dryer combined washing machine may include a hot air supply device for supplying high-temperature air into the drum and a condensing device for removing moisture from air discharged from the drum. For example, the dryer combined washing machine may include a heat pump device. The washing machine according to various embodiments may include a washing machine using a washing method other than the above-described washing method.

The washing machine according to various embodiments may include a main body accommodating various components therein. The main body may be provided in the form of a box including a laundry inlet on one side thereof.

The washing machine may include a door for opening and closing the laundry inlet. The door may be rotatably mounted to the main body by a hinge. At least a portion of the door may be transparent or translucent to allow the inside of the main body to be visible.

The washing machine may include a tub disposed within the main body to store water. The tub may be formed in a substantially cylindrical shape with a tub opening formed on one side thereof. The tub may be disposed inside the main body in such a way that the tub opening corresponds to the laundry inlet.

The tub may be connected to the main body by a damper. The damper may absorb vibration generated when the drum rotates, and the damper may reduce vibration transmitted to the main body.

The washing machine may include a drum provided to accommodate laundry.

The drum may be disposed inside the tub such that a drum opening provided on one side of the drum corresponds to the laundry inlet and the tub opening. Laundry may pass sequentially through the laundry inlet, the tub opening, and the drum opening and then be received in the drum or removed from the drum.

The drum may perform each operation according to washing, rinsing, and/or spin-drying while rotating in the tub. A plurality of through holes may be formed in a cylindrical wall of the drum to allow water stored in the tub to be introduced into or to be discharged from the drum.

The washing machine may include a driving device configured to rotate the drum. The driving device may include a drive motor and a rotating shaft for transmitting a driving force generated by the drive motor to the drum. The rotating shaft may penetrate the tub to be connected to the drum.

The driving device may perform respective operations according to washing, rinsing, and/or spin-drying, or drying processes by rotating the drum in a forward or reverse direction.

The washing machine may include a water supply device configured to supply water to the tub. The water supply device may include a water supply pipe and a water supply valve disposed in the water supply pipe. The water supply pipe may be connected to an external water supply source. The water supply pipe may extend from an external water supply source to a detergent supply device and/or the tub. Water may be supplied to the tub through the detergent supply device. Alternatively, water may be supplied to the tub without passing through the detergent supply device.

The water supply valve may open or close the water supply pipe in response to an electrical signal from a controller. The water supply valve may allow or block the supply of water to the tub from an external water supply source. The water supply valve may include a solenoid valve configured to open or close in response to an electrical signal.

The washing machine may include the detergent supply device configured to supply detergent to the tub. The detergent supply device may include a manual detergent supply device that requires a user to enter detergent to be used for each washing, and an automatic detergent supply device that stores a large amount of detergent and automatically adds a predetermined amount of detergent during washing. The detergent supply device may include a detergent container for storing detergent. The detergent supply device may be configured to supply detergent into the tub during a water supply process. Water supplied through the water supply pipe may be mixed with detergent via the detergent supply device. Water mixed with detergent may be supplied into the tub. Detergent is used as a term including detergent for pre-washing, detergent for main washing, fabric softener, bleach, etc., and the detergent container may be partitioned into a storage region for the pre-washing detergent, a storage region for the main washing detergent, a storage region for the fabric softener, and a storage region for the bleach.

The washing machine may include a drainage device configured to discharge water contained in the tub to the outside. The drainage device may include a drain pipe extending from a bottom of the tub to the outside of the main body, a drain valve disposed on the drain pipe to open or close the drain pipe, and a pump disposed on the drain pipe. The pump may pump water from the drain pipe to the outside of the main body.

The washing machine may include a control panel disposed on one side of the main body. The control panel may provide a user interface for interaction between a user and the washing machine. The user interface may include at least one input interface and at least one output interface.

The at least one input interface may convert sensory information received from a user into an electrical signal.

The at least one input interface may include a power button, an operation button, a course selection dial (or a course selection button), and a washing/rinsing/spin-drying setting button. The at least one input interface may include a tact switch, a push switch, a slide switch, a toggle switch, a micro switch, a touch switch, a touch pad, a touch screen, a jog dial, and/or a microphone.

The at least one output interface may visually or audibly transmit information related to the operation of the washing machine to a user.

For example, the at least one output interface may transmit information related to a washing course, operation time of the washing machine, and washing/rinsing/spin-drying settings to the user. Information about the operation of the washing machine may be output via a screen, an indicator, or a voice. The at least one output interface may include a liquid crystal display (LCD) panel, a light emitting diode (LED) panel, or a speaker.

The washing machine may include a communication module for wired and/or wireless communication with an external device.

The communication module may include at least one of a short-range wireless communication module and a long-range wireless communication module.

The communication module may transmit data to an external device (e.g., a server, a user device, and/or a home appliance) or receive data from the external device. For example, the communication module may establish communication with a server and/or a user device and/or a home appliance, and transmit and receive various types of data.

For the communication, the communication module may establish a direct (e.g., wired) communication channel or a wireless communication channel between the external devices, and support the performance of the communication through the established communication channel. According to an embodiment, the communication module may include a wireless communication module (e.g., a cellular communication module, a short-range wireless communication module, or a global navigation satellite system (GNSS) communication module) or a wired communication module (e.g., a local area network (LAN) communication module, or a power line communication module). Among these communication modules, the corresponding communication module may communicate with an external device through a first network (e.g., a short-range wireless communication network such as Bluetooth, wireless fidelity (Wi-Fi) direct, or infrared data association (IrDA)) or a second network (e.g., a long-range wireless communication network such as a legacy cellular network, a 5G network, a next-generation communication network, the Internet, or a computer network (e.g., LAN or wide area network WAN)). These various types of communication modules may be integrated as a single component (e.g., a single chip) or implemented as a plurality of separate components (e.g., multiple chips).

The short-range wireless communication module may include a Bluetooth communication module, a Bluetooth Low Energy (BLE) communication module, a near field communication module, a WLAN (Wi-Fi) communication module, and a Zigbee communication module, an IrDA communication module, a Wi-Fi Direct (WFD) communication module, an ultrawideband (UWB) communication module, an Ant+communication module, a microwave (uWave) communication module, etc., but is not limited thereto.

The long-range wireless communication module may include a communication module that performs various types of long-range wireless communication, and may include a mobile communication circuitry. The mobile communication circuitry transmits and receives radio signals with at least one of a base station, an external terminal, and a server in a mobile communication network.

According to an embodiment, the communication module may communicate with an external device such as a server, a user device and other home appliances through an access point (AP). The AP may connect a LAN, to which a washing machine or a user device is connected, to a WAN to which a server is connected. The washing machine or the user device may be connected to the server via the WAN. The controller may control various components of the washing machine (e.g., the drive motor, and the water supply valve). The controller may control various components of the washing machine to perform at least one operation including water supply, washing, rinsing, and/or spin-drying according to a user input. For example, the controller may control the drive motor to adjust the rotational speed of the drum or control the water supply valve of the water supply device to supply water to the tub.

The controller may include hardware such as a CPU or memory, and software such as a control program. For example, the controller may include at least one memory for storing an algorithm and program-type data for controlling the operation of components in the washing machine, and at least one processor configured to perform the above-mentioned operation by using the data stored in the at least one memory. The memory and the processor may each be implemented as separate chips. The processor may include one or more processor chips or may include one or more processing cores. The memory may include one or more memory chips or one or more memory blocks. Alternatively, the memory and the processor may be implemented as a single chip.

In the following detailed description, the terms of “upper side”, “lower side”, “front side”, “rear side”, “left side”, “right side” and the like may be defined by the drawings, but the shape and the location of the component is not limited by the term. For example, the terms “upper side” and “lower side” below may each be defined based on the Z-direction illustrated in the drawings. The terms “front side” and “rear side” below may each be defined based on the X-direction illustrated in the drawings. The terms “left side” and “right side” below may each be defined based on the Y-direction illustrated in the drawings.

Hereinafter embodiments according to the present disclosure will be described in detail with reference to the attached drawings.

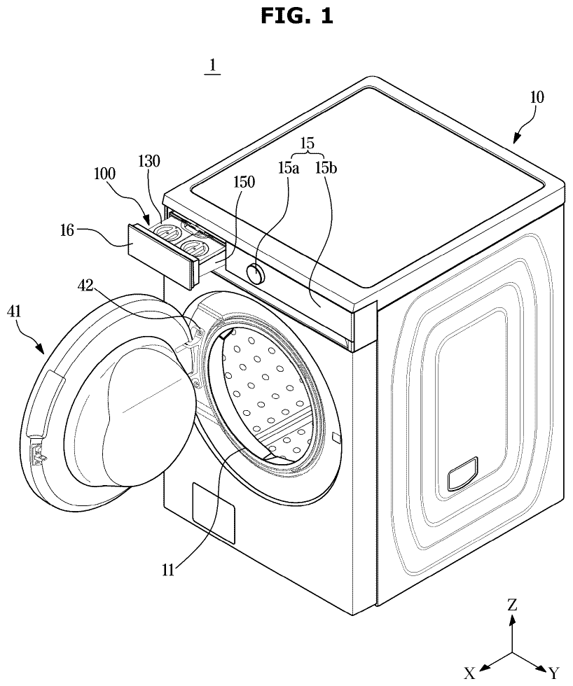

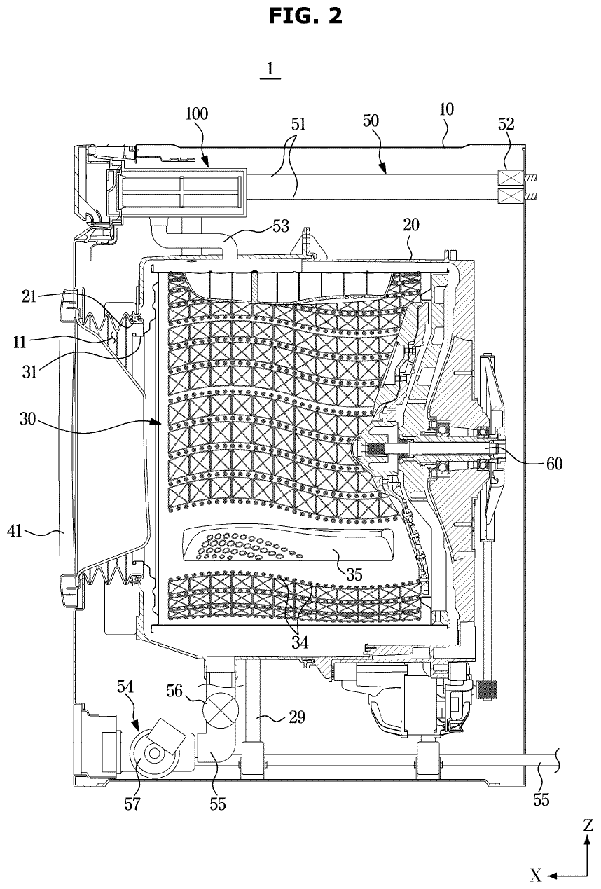

FIG. 1 is a perspective view illustrating a washing machine according to one embodiment of the present disclosure. FIG. 2 is a cross-sectional view of the washing machine according to one embodiment of the present disclosure.

Referring to FIGS. 1 and 2, a washing machine 1 according to one embodiment of the present disclosure may include a main body 10 provided to accommodate various components therein. The main body 10 may form an exterior of the washing machine 1. A laundry inlet 11 may be formed on one side of the main body 10. The main body 10 may be formed in a box shape with the laundry inlet 11 formed approximately on one side. The laundry inlet 11 may be formed on the front side of the main body 10.

The main body 10 may include a control panel 15. The control panel 15 may include an input device 15a provided to obtain a user input. The control panel 15 may include a display 15b provided to output operation information of the washing machine 1. That is, the control panel 15 may provide a user interface 15 for interaction between a user and the washing machine.

For example, the control panel 15 may be provided on the front surface of the main body 10. For example, the control panel 15 may be provided on the upper portion of the main body 10.

The main body 10 may include a detergent box panel 16. The detergent box panel 16 may be coupled to a detergent box 150 to be described later. The detergent box panel 16 may be provided to allow a user to pull out the detergent box 150 from the main body 10 or insert the detergent box 150 into the main body 10 by gripping the detergent box panel 16.

For example, the detergent box panel 16 may be provided in a front portion of the main body 10 and may be coupled to a front portion of the detergent box 150. For example, the detergent box panel 16 may be provided at the upper portion of the main body 10.

The washing machine 1 may include a door 41 configured to open and close the laundry inlet 11. The door 41 may be rotatably coupled to the main body 10 to open or close the laundry inlet 11. The door 41 may be rotatably coupled to the main body 10 by a hinge 42. The door 41 may be coupled to the front portion of the main body 10.

The washing machine 1 may include a tub 20 disposed inside the main body 10. The tub 20 may be provided to store mixed water containing washing water and detergent.

A tub opening 21 may be formed on one side of the tub 20. The tub opening 21 may be arranged to correspond to the laundry inlet 11. For example, the tub 20 may be formed in a cylindrical shape with the tub opening 21 formed on approximately one side.

The tub 20 may be connected to a damper 29. The tub 20 may be connected to the main body 10 by the damper 29. The tub 20 may be supported by the damper 29. The damper 29 may absorb vibrations generated when the drum 30 rotates, and attenuate vibrations transmitted to the main body 10.

The washing machine 1 may include a drum 30 disposed inside the tub 20. The drum 30 may be provided to accommodate laundry inside. The drum 30 may be configured to be rotatable relative to the tub 20 inside the tub 20. The drum 30 may perform each operation according to the process of washing, rinsing, and spin-drying while rotating inside the tub 20.

A drum opening 31 may be formed on one side of the drum 30. The drum opening 31 may be arranged to correspond to the laundry inlet 11 and the tub opening 21. Laundry may be sequentially passed through the laundry inlet 11, the tub opening 21, and the drum opening 31 and then inserted into the drum 30. Conversely, laundry may be sequentially passed through the drum opening 31, the tub opening 21, and the laundry inlet 11 and then withdrawn from the drum 30.

The drum 30 may include a plurality of through-holes 34 formed to allow water stored in the tub 20 to flow into the drum 30 or to allow water inside the drum 30 to be discharged to the outside of the drum 30.

At least one lifter 35 formed to allow laundry to rise and fall when the drum 30 rotates may be formed on an inner circumferential surface of the drum 30.

The washing machine 1 may include a driving device 60 configured to rotate the drum 30. The driving device 60 may include a driving motor configured to generate power for rotating the drum 30 and a rotating shaft for transmitting the power generated by the driving motor to the drum 30. The rotating shaft may pass through the tub 20 and be connected to the drum 30. The driving device 60 may perform each operation according to the process, such as washing, rinsing, and spin-drying, by rotating the drum 30 forward or reverse.

The washing machine 1 may include a water supply device 50 configured to supply washing water to the tub 20. The water supply device 50 may include a water supply pipe 51 connected to an external water source, and a water supply valve 52 configured to open and close the water supply pipe 51. The water supply pipe 51 may extend from the external water source to a detergent supply device 100 described below, and washing water may be supplied to the tub 20 via the detergent supply device 100. Alternatively, the water supply pipe 51 may extend from the external water source to the tub 20, and washing water may be supplied to the tub 20 without passing through the detergent supply device 100.

For example, the water supply pipe 51 may be disposed in the upper portion of the main body 10.

The washing machine 1 may include the detergent supply device 100. The detergent supply device 100 may be configured to supply detergent to the tub 20. The detergent supply device 100 may be configured to supply a mixture of detergent and washing water to the tub 20.

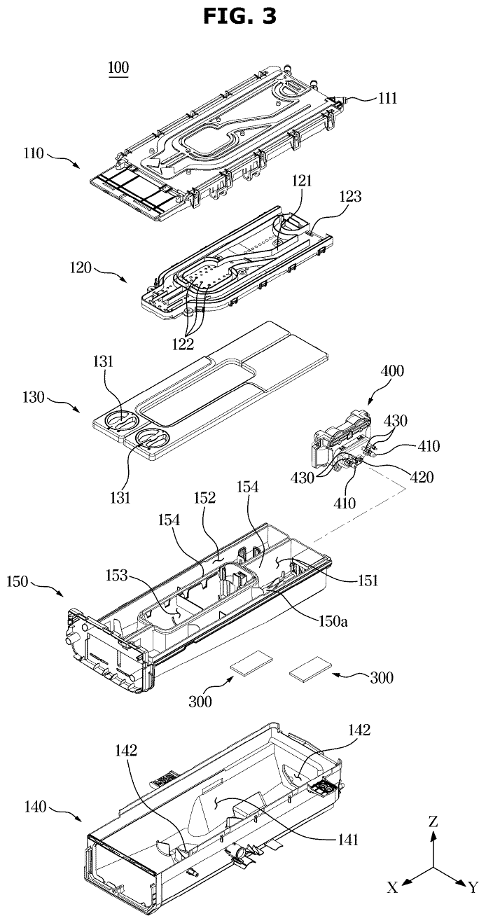

The detergent supply device 100 may include a detergent box 150 (refer to FIG. 3) for storing detergent. The detergent supply device 100 may be configured to supply detergent stored in the detergent box 150 into the inside of the tub 20 during a water supply process. Water supplied through the water supply pipe 51 may pass through the detergent supply device 100 and be mixed with detergent. The water mixed with detergent may be supplied into the inside of the tub 20.

The detergent supply device 100 may be connected to the tub 20 through a connecting pipe 53. Water mixed with detergent in the detergent supply device 100 may be supplied into the inside of the tub 20 through the connecting pipe 53.

For example, the detergent supply device 100 may be disposed in the upper portion of the main body 10. For example, the detergent supply device 100 may be disposed above the tub 20.

The washing machine 1 may include a drain device 54 configured to discharge water inside the tub 20 to the outside. The drain device 54 may include a drain pipe 55 extending from a lower portion of the tub 20 to the outside of the main body 10, a drain valve 56 configured to open and close the drain pipe 55, and a drain pump 57 disposed on the drain pipe 55.

The configurations of the washing machine 1 described above with reference to FIGS. 1 and 2 are merely examples of configurations that may be included in the washing machine 1 according to one embodiment of the present disclosure, and the washing machine 1 may include various configurations for performing functions such as washing laundry.

In the above, a front-loading type washing machine 1 has been described as an example with reference to FIGS. 1 and 2, but the washing machine according to the present disclosure is not limited thereto. The present disclosure may be applied to a top-loading type washing machine.

Hereinafter configurations of the washing machine 1 according to one embodiment of the present disclosure such as the detergent supply device 100 will be described in more detail with reference to FIGS. 3 to 23.

FIG. 3 is a view illustrating a detergent supply device of the washing machine according to one embodiment of the present disclosure.

Referring to FIG. 3, the detergent supply device 100 of the washing machine 1 according to one embodiment of the present disclosure may include the detergent box 150. The detergent box 150 may be provided to store detergent to be supplied to the tub 20.

The detergent box 150 may form a receiving chamber for receiving detergent. The receiving chamber of the detergent box 150 may receive various types of detergent, such as pre-wash detergent, main wash detergent, fabric softener, and bleach.

For example, the detergent box 150 may include a first receiving chamber 151 formed to receive liquid laundry detergent. For example, the detergent box 150 may include a second receiving chamber 152 formed to receive fabric softener. Hereinafter the liquid laundry detergent that may be received in the first receiving chamber 151 and the fabric softener that may be received in the second receiving chamber 152 are collectively referred to as “liquid detergent” for convenience. The types of liquid detergent that may be received in the first receiving chamber 151 and the second receiving chamber 152 are not limited to the above examples.

The first receiving chamber 151 and the second receiving chamber 152 may be partitioned from each other. The detergent box 150 may include a chamber partition 154 formed on the inside of the detergent box 150 to define the first receiving chamber 151 and the second receiving chamber 152. For example, the chamber partition 154 may extend upward from a bottom surface 150a of the detergent box 150.

For example, the detergent box 150 may further include a third receiving chamber 153 formed to receive laundry detergent in powder form. The third receiving chamber 153 may be partitioned from the first receiving chamber 151 and the second receiving chamber 152. The first receiving chamber 151, the second receiving chamber 152, and the third receiving chamber 153 may be partitioned from each other by the chamber partition 154.

FIG. 3 illustrates that the first receiving chamber 151 is formed on the right side of the detergent box 150 and the second receiving chamber 152 is formed on the left side of the detergent box 150, but the positions of the first receiving chamber 151 and the second receiving chamber 152 are not limited thereto. In addition, FIG. 3 illustrates that the third receiving chamber 153 is disposed between the first receiving chamber 151 and the second receiving chamber 152, but the position of the third receiving chamber 153 is not limited thereto.

The detergent box 150 may be configured to be movable with respect to the main body 10. As described above, the detergent box 150 may be configured to be inserted into the main body 10 or withdrawn from the main body 10. Particularly, the detergent box 150 may be movably mounted to a housing 140 to be described later. The detergent box 150 may be mounted to the housing 140 to be inserted into the housing 140 or withdrawn from the housing 140.

The detergent box 150 may be formed to allow one side thereof to be open. Particularly, the detergent box 150 may be formed to allow an upper side thereof to be open. The detergent box 150 may be formed to allow an upper side of the receiving chamber to be open, and thus detergent may be introduced into the receiving chamber. The first receiving chamber 151, the second receiving chamber 152, and the third receiving chamber 153 may each be formed to allow an upper side thereof to be open.

The detergent supply device 100 may include a detergent box cover 130 provided to cover the detergent box 150. The detergent box cover 130 may be disposed in the upper portion of the detergent box 150. The detergent box cover 130 may be detachably coupled to the upper portion of the detergent box 150.

For example, the detergent box cover 130 may cover the first receiving chamber 151. For example, the detergent box cover 130 may cover the second receiving chamber 152. Alternatively, the third receiving chamber 153 may not be covered by the detergent box cover 130.

A detergent inlet provided to allow detergent to be inserted into the detergent box 150 may be formed in the detergent box cover 130, and the detergent inlet may be opened and closed by a detergent box cap 131. The detergent box cap 131 may be detachably coupled to the detergent box cover 130. For example, the detergent box cap 131 may be provided in plurality to open and close the first receiving chamber 151 and the second receiving chamber 152, respectively.

Hereinafter a configuration, in which detergent stored in the detergent box 150 is discharged and the detergent discharged from the detergent box 150 is mixed with water and discharged into the tub 20, is described in detail with an example.

The detergent supply device 100 may include a water supply cover 110. The water supply cover 110 may form the exterior of the detergent supply device 100 together with the housing 140 to be described later. The water supply cover 110 may be coupled to an upper portion of a water supply plate 120 to be described later. The water supply cover 110 may be coupled to the water supply plate 120 to seal an upper surface of the water supply plate 120. The water supply cover 110 may be coupled to the water supply plate 120 to form a flow path through which washing water supplied from the water supply pipe 51 moves.

The water supply cover 110 may include a washing water inlet 111 connected to the water supply pipe 51. Washing water supplied from the water supply pipe 51 may flow into the detergent supply device 100 through the washing water inlet 111.

The detergent supply device 100 may include the water supply plate 120 coupled to the water supply cover 110. The water supply plate 120 may be disposed between the water supply cover 110 and the housing 140. The water supply plate 120 may be disposed between the water supply cover 110 and the detergent box 150. The water supply plate 120 may be disposed between the water supply cover 110 and the detergent box cover 130. For example, the water supply plate 120 may be disposed above the detergent box cover 130. The water supply plate 120 may include a guide partition 121 provided to define a flow path through which washing water flows. Together with the water supply cover 110, the water supply plate 120 may form a flow path, through which washing water supplied from the water supply pipe moves.

The water supply plate 120 may include a first water flow hole 122 formed to allow washing water, which flows from the water supply pipe 51 into a space between the water supply cover 110 and the water supply plate 120, to be discharged to the third receiving chamber 153. The first water flow hole 122 may have a shape formed by penetrating the water supply plate 120. The first water flow hole 122 may be formed in a region of the water supply plate 120 facing the third receiving chamber 153. As described above, because the third receiving chamber 153 is not covered by the detergent box cover 130, washing water between the water supply cover 110 and the water supply plate 120 may flow to the third receiving chamber 153 through the first water flow hole 122.

The water supply plate 120 may include a second water flow hole 123 formed to allow a portion of washing water, which flows from the water supply pipe 51, to flow directly into the inside of the housing 140 (i.e., a mixing chamber 141 to be described later) without passing through the flow path. The second water flow hole 123 may have a shape formed by penetrating the water supply plate 120. For example, the second water flow hole 123 may be formed on the upstream side of the first washing water flow hole 122. The second water flow hole 123 may be arranged adjacent to the washing water inlet 111.

The detergent supply device 100 may include the housing 140 that forms the exterior of the detergent supply device 100 together with the water supply cover 110. The housing 140 may be mounted on the main body 10. The housing 140 may be fixed to the main body 10.

The housing 140 may cover the detergent box 150. The housing 140 may movably support the detergent box 150. For example, an opening may be formed on a front surface of the housing 140. The detergent box 150 may be provided to be withdrawn from the housing 140 or inserted into the housing 140 through the opening on the front surface of the housing 140.

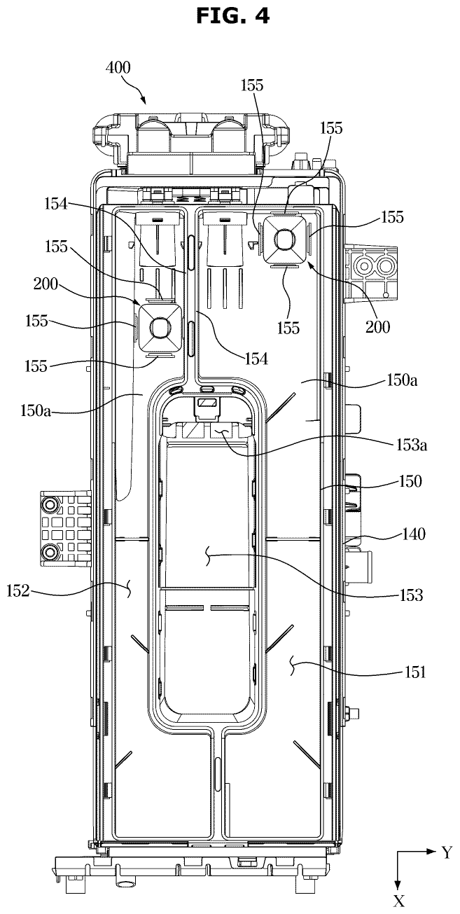

The housing 140 may include the mixing chamber 141 formed on the inside of the housing 140. Liquid detergent in the first receiving chamber 151 or the second receiving chamber 152 may be moved to the mixing chamber 141 by the detergent pump 400 and then supplied to the tub 20. The third receiving chamber 153 may be connected to the mixing chamber 141 through a communication port 153a (refer to FIG. 4), and powder detergent stored in the third receiving chamber 153 may be mixed with washing water, which is introduced through the first water flow hole 122, in the third receiving chamber 153. The mixed water in which the powder detergent and washing water are mixed may be moved to the mixing chamber 141 through the communication port 153a.

A discharge port 142 provided to allow detergent or washing water to be discharged from the mixing chamber 141 to the outside of the detergent supply device 100 may be formed in the lower portion of the housing 140. The discharge port 142 may be connected to the connecting pipe 53. The discharge port 142 may be connected to the tub 20 through the connecting pipe 53, and the detergent or washing water in the mixing chamber 141 may be discharged through the discharge port 142 and then supplied to the tub 20 through the connecting pipe 53.

The detergent supply device 100 may include the detergent pump 400. The detergent pump 400 may be configured to move detergent stored in the detergent box 150 to the mixing chamber 141. The detergent pump 400 may be configured to draw in detergent from the detergent box 150 and discharge the drawn detergent into the mixing chamber 141. For example, the detergent pump 400 may be configured to draw in detergent from the first receiving chamber 151 or the second receiving chamber 152 and discharge the drawn detergent into the mixing chamber 141.

For example, the detergent pump 400 may be disposed on the rear side of the detergent box 150. For example, the detergent pump 400 may be mounted at the rear side of the housing 140. The housing 140 may include a pump opening 143 formed to allow the detergent pump 400 to penetrate and be mounted therethrough.

The detergent pump 400 may include a detergent inlet 410 provided to draw in detergent from the detergent box 150. For example, the detergent inlet 410 may be formed to penetrate the rear surface of the detergent box 150. The detergent inlet 410 may be provided to penetrate the detergent box 150 and thus a portion of the detergent inlet 410 may be inserted into the detergent box 150. The detergent inlet 410 may be provided in plurality, and the plurality of detergent inlet 410 may be provided to draw in detergent from the first receiving chamber 151 and the second receiving chamber 152, respectively.

The detergent pump 400 may include a detergent outlet 420 configured to discharge detergent, which is drawn from the detergent box 150, into the mixing chamber 141. For example, the detergent outlet 420 may be formed to penetrate the rear surface of the housing 140. The detergent outlet 420 may be formed to penetrate the pump opening 143.

A driving motor (not shown) configured to generate power may be disposed inside the detergent pump 400. The driving motor of the detergent pump 400 may be controlled by a controller of the washing machine 1.

The configurations of the detergent supply device 100 described above with reference to FIG. 3 are merely examples of configurations that may be included in the detergent supply device 100 of the washing machine 1 according to one embodiment of the present disclosure, and the present disclosure is not limited thereto.

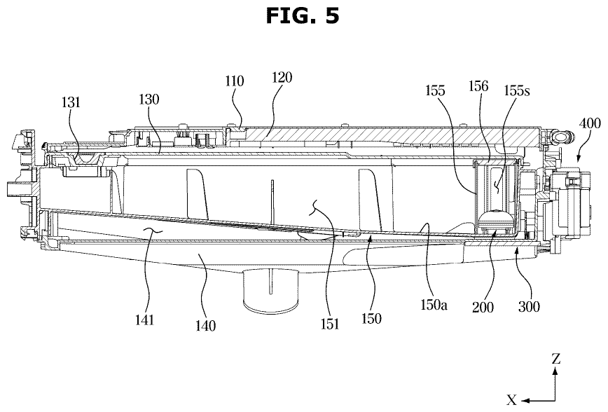

FIG. 4 is a top view of some components separated from the detergent supply device of the washing machine according to one embodiment of the present disclosure. FIG. 5 is a cross-sectional view of the detergent supply device of the washing machine according to one embodiment of the present disclosure.

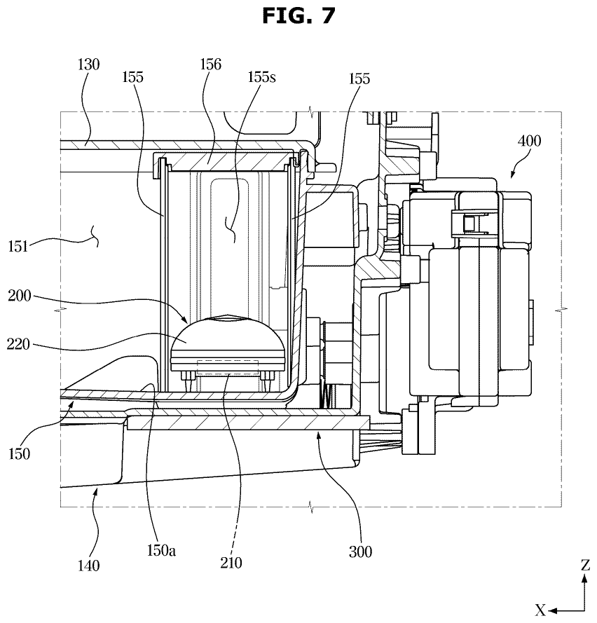

Referring to FIGS. 4 and 5, the detergent supply device 100 of the washing machine 1 according to one embodiment of the present disclosure may include a detergent amount detection device configured to detect the amount of liquid detergent stored in the detergent box 150. The detergent amount detection device may include a floating device 200 including a magnet 210 (refer to FIG. 7, etc.) and a magnetic field sensor 300 configured to detect a magnetic field by the magnet 210 of the floating device 200.

The floating device 200 may be disposed in the detergent box 150. The floating device 200 may be configured to be movable within the detergent box 150. The floating device 200 may be configured to float within the detergent box 150 due to the buoyancy of the liquid detergent when the liquid detergent is stored within the detergent box 150 at a predetermined height or higher. When an amount of the liquid detergent within the detergent box 150 is less than a predetermined amount, the buoyancy of the liquid detergent may be not sufficient, and thus the floating device 200 may be positioned close to the bottom surface 150a of the detergent box 150. When the amount of the liquid detergent within the detergent box 150 is the predetermined amount or more, the floating device 200 may float due to the buoyancy of the liquid detergent and rise upward from the bottom surface 150a of the detergent box 150. As the amount of the liquid detergent increases after the amount of liquid detergent in the detergent box 150 is greater than the predetermined amount, the floating device 200 may rise higher from the bottom surface 150a of the detergent box 150. Conversely, as the amount of liquid detergent in the detergent box 150 decreases, the floating device 200 may descend toward the bottom surface 150a of the detergent box 150. That is, the floating device 200 may be configured to be movable in the vertical direction Z depending on the height of the liquid detergent in the detergent box 150.

The magnetic field sensor 300 may be disposed on one side of the floating device 200. The magnetic field sensor 300 may be disposed on one side of the floating device 200 in the moving direction. Particularly, the magnetic field sensor 300 may be disposed below the floating device 200. As the floating device 200 rises or falls due to the buoyancy of the liquid detergent, an intensity of the magnetic field by the magnet 210 (FIG. 7, etc.) of the floating device 200 detected by the magnetic field sensor 300 may change. The detergent amount detection device may detect a remaining amount of the liquid detergent stored in the detergent box 150 by utilizing a change in the intensity of the magnetic field.

The magnetic field sensor 300 may include various types of magnetic field sensors, such as a Hall sensor.

As illustrated in FIG. 5, the magnetic field sensor 300 may be disposed below the detergent box 150. For example, the magnetic field sensor 300 may be mounted on the lower portion of the housing 140. Alternatively, the magnetic field sensor 300 may be disposed between the detergent box 150 and the housing 140. Alternatively, the magnetic field sensor 300 may be mounted on the lower portion of the detergent box 150. Alternatively, the magnetic field sensor 300 may be disposed on the inner side of the detergent box 150. The magnetic field sensor 300 may be disposed at various locations in which the magnetic field sensor 300 efficiently detects a magnetic field generated by the magnet 210 (refer to FIG. 7, etc.) of the floating device 200.

For example, the magnetic field sensor 300 may be mounted on the detergent box 150 or the housing 140 by a hook structure. For example, the magnetic field sensor 300 may be fixed to the detergent box 150 or the housing 140 by a fastening member such as a screw. The present disclosure is not limited thereto, and the magnetic field sensor 300 may be fixed to the detergent box 150 or the housing 140 by various structures.

For example, the floating device 200 may be provided in plurality to be respectively disposed in the first receiving chamber 151 and the second receiving chamber 152. For example, the plurality of floating devices 200 may have structures corresponding to each other.

The magnetic field sensor 300 may be provided in plurality to correspond to the plurality of floating devices 200. Some of the plurality of magnetic field sensors 300 may be disposed on one side of some of the plurality of floating devices 200 to detect a magnetic field by a magnet 210 of the some of the plurality of floating devices 200. Others of the plurality of magnetic field sensors 300 may be arranged on one side of others of the floating devices 200 to detect a magnetic field by a magnet 210 of the others of the floating devices 200.

The floating device 200 and the magnetic field sensor 300 corresponding to the floating device 200 disposed in the first receiving chamber 151 may be configured to detect the amount of liquid detergent stored in the first receiving chamber 151. The floating device 200 and the magnetic field sensor 300 corresponding to the floating device 200 disposed in the second receiving chamber 152 may be configured to detect the amount of liquid detergent stored in the second receiving chamber 152.

As the bottom surface 150a of the detergent box 150 may be formed to be inclined downward toward the rear. As the bottom surface 150a of the detergent box 150 is inclined downward toward the rear, the liquid detergent may have a tendency to move rearward within the detergent box 150. Accordingly, the detergent pump 400 may be arranged at the rear side of the detergent box 150 to more efficiently draw in the detergent within the detergent box 150. Correspondingly, the floating device 200 may be arranged at the rear side of the detergent box 150. The floating device 200 may be arranged at a position adjacent to the detergent pump 400 within the detergent box 150. Accordingly, the detergent amount detection device may more efficiently and accurately detect a remaining amount of liquid detergent within the detergent box 150.

For example, the floating device 200 may be disposed so as to be almost in contact with the rear end of the receiving chamber, such as the floating device 200 accommodated in the first receiving chamber 151. Alternatively, the floating device 200 may be disposed at a predetermined distance from the rear end of the receiving chamber, such as the floating device 200 accommodated in the second receiving chamber 152.

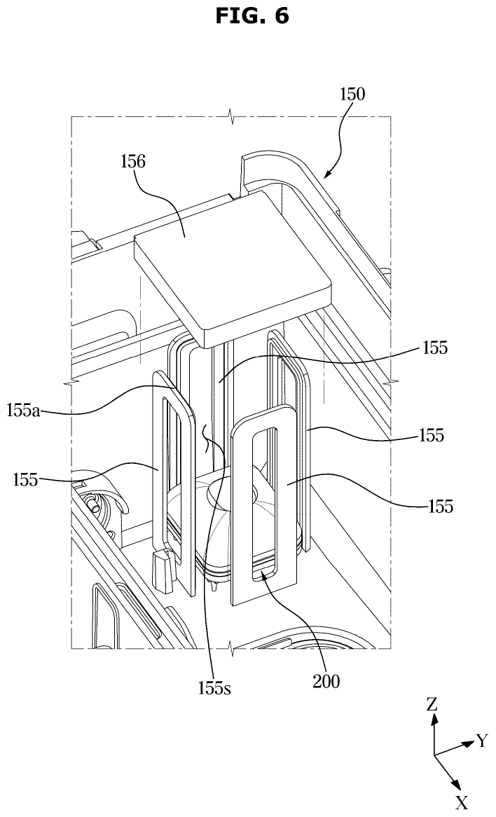

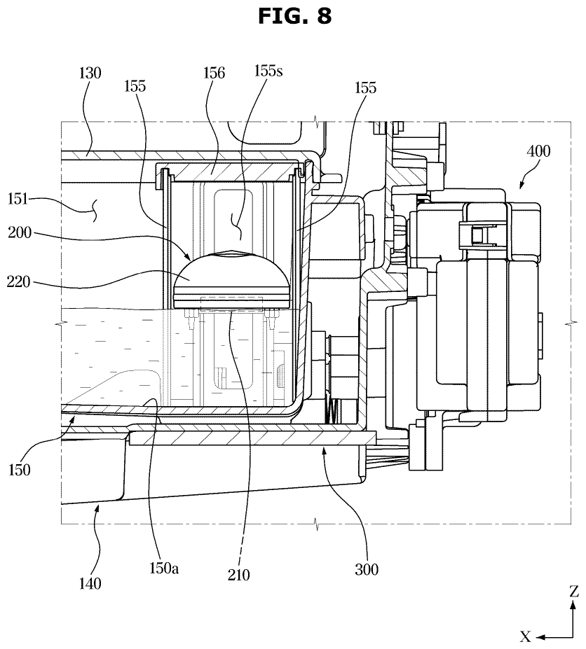

FIG. 6 is a view illustrating some components of the detergent supply device, such as a detergent box and a floating device, of the washing machine according to one embodiment of the present disclosure. FIG. 7 is an enlarged view of some components, such as the detergent box, the floating device, and a magnetic field sensor, in the detergent supply device of the washing machine according to one embodiment of the present disclosure when the floating device is at a bottom position. FIG. 8 is an enlarged view of some components, such as the detergent box, the floating device, and the magnetic field sensor, in the detergent supply device of the washing machine according to one embodiment of the present disclosure when the floating device is at a floating position.

FIGS. 6 to 8 illustrate in detail the floating device 200 accommodated in the first receiving chamber 151 of the detergent box 150 and the magnetic field sensor 300 corresponding thereto, but the following description may also be applied to the floating device 200 accommodated in the second receiving chamber 152 and the magnetic field sensor 300 corresponding thereto.

Referring to FIGS. 6 to 8, the floating device 200 provided in the detergent supply device 100 of the washing machine 1 according to one embodiment of the present disclosure may include the magnet 210 and a floating case 220 supporting the magnet 210.

The magnet 210 may include a magnetic body of various materials that may have sufficient magnetism to allow the magnetic field sensor 300 to detect the magnetic field.

The floating case 220 may be configured to be movable within the detergent box 150. The floating case 220 may be configured to be movable in the vertical direction Z depending on a height of the liquid detergent within the detergent box 150. The floating case 220 may rise or fall depending on the height of the liquid detergent within the detergent box 150.

The floating case 220 supports the magnet 210, and thus, when the floating case 220 rises or falls within the detergent box 150, the magnet 210 may also rise or fall together with the floating case 220.

The floating case 220 may accommodate the magnet 210. The floating case 220 may form an accommodation space disposed therein and provided to accommodate the magnet 210.

The floating device 200 may be designed to have a low density to float by liquid detergent as a whole, including the magnet 210 and the floating case 220.

The floating case 220 may be configured to have a low density to easily float even by a small amount of liquid detergent. The floating case 220 may be formed of a material including a low specific gravity material.

In addition, because the floating case 220 is used while continuously exposed to liquid detergent in the detergent box 150, it is appropriate that the floating case 220 is composed of a material including a material with high water-repellent or detergent-resistant properties.

For example, the floating case 220 may be composed of a material including polypropylene (PP) material having low specific gravity and high water-repellent and detergent-resistant properties.

However, the present disclosure is not limited thereto, and the floating case 220 may include various materials.

The floating device 200 may be configured to be movable between a bottom position (e.g., FIG. 7) adjacent to the bottom surface 150a of the detergent box 150 and a floating position (e.g., FIG. 8) rising from the bottom position by the buoyancy due to liquid detergent in the detergent box 150.

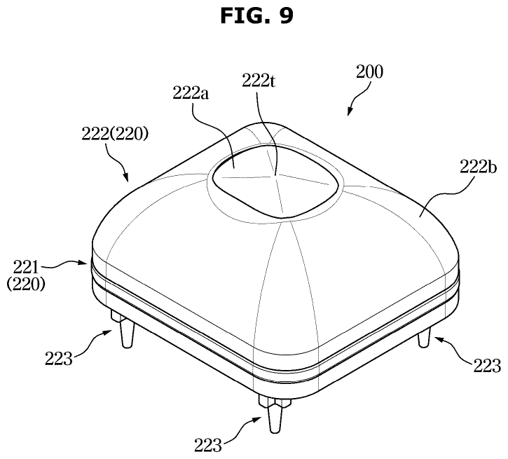

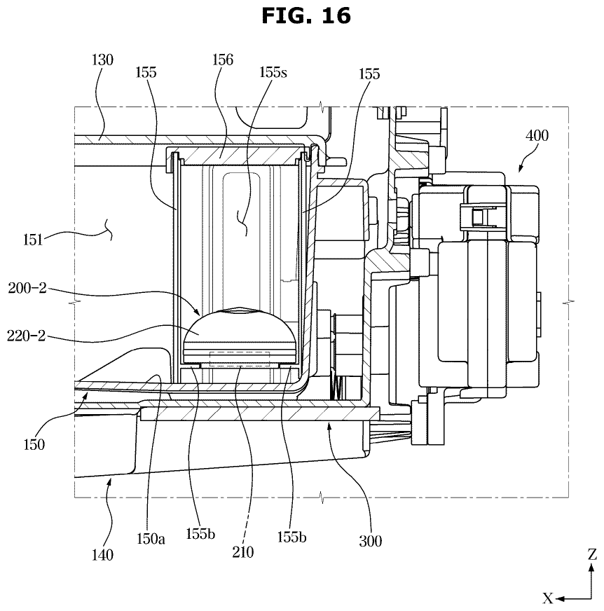

The bottom position of the floating device 200 may be defined as a position in which the floating case 220 is the lowest with respect to the vertical direction Z within the detergent box 150. That is, the bottom position of the floating device 200 may be defined as a position in which the floating case 220 is supported in contact with the bottom surface 150a of the detergent box 150 or as a position in which the lower portion of the floating case 220 is supported in contact with another structure (e.g., a guide rib 155, refer to one embodiment of FIG. 16) provided in the lower portion of the detergent box 150. When the floating device 200 is positioned at the bottom position, legs 223 (refer to FIG. 9, etc.) of the floating case 220 described below may be in contact with the bottom surface 150a of the detergent box 150. Alternatively, when the floating device 200 is positioned at the bottom position, the lower portion of the floating case 220 may be in contact with a support portion 155b of the guide rib 155 described later.

The floating position of the floating device 200 may be defined as a position in which the floating case 220 is raised by being separated from the bottom surface 150a of the detergent box 150 or other structures in the lower portion of the detergent box 150 and mean a continuous range of positions in which the floating device 200 floats at a certain range of heights by the liquid detergent, rather than a position at a specific height. In other words, the floating position of the floating device 200 may be defined as all ranges of positions in which the floating device 200 may be positioned by moving vertically upward from the bottom position within the detergent box 150. When the floating device 200 is positioned at the floating position, the legs 223 (refer to FIG. 9, etc.) of the floating case 220 described below may be separated from the bottom surface 150a of the detergent box 150. Alternatively, when the floating device 200 is positioned at the floating position, the floating case 220 may be spaced apart from the support portion 155b of the guide rib 155 described later.

As illustrated in FIGS. 7 and 8, a distance between the magnet 210 and the magnetic field sensor 300 may vary depending on the position of the floating device 200 within the detergent box 150. When the distance between the magnet 210 and the magnetic field sensor 300 varies, the intensity of the magnetic field detected by the magnet 210 by the magnetic field sensor 300 varies.

The following Table 1 illustrates the relationship between an amount of magnetic field change detected by the magnetic field sensor 300 and the amount of liquid detergent in the detergent box 150 when the magnetic field sensor 300 is placed on the lower side of the floating device 200, as an example. The amount of magnetic field change detected by the magnetic field sensor 300 may be defined as a difference between an intensity of a magnetic field by the magnet 210 when the floating device 200 is located at the bottom position (bottom magnetic field intensity) and an intensity of a magnetic field by the magnet 210 when the magnetic field sensor 300 measures the magnetic field (measured magnetic field intensity).

When the floating device 200 is located at the bottom position in a state in which the magnetic field sensor 300 is placed on the lower side of the floating device 200, the intensity of the magnetic field detected by the magnetic field sensor 300 may be the greatest. When the floating device 200 rises to the floating position due to the liquid detergent, the intensity of the magnetic field detected by the magnetic field sensor 300 may decrease. The floating device 200 may not float when there is a very small amount of liquid detergent in the detergent box 150, and hereinafter the minimum remaining amount of liquid detergent for the floating device 200 to be located at the floating position in the detergent box 150 is referred to as the ‘reference detergent amount’. The reference detergent amount may vary depending on a density of the floating device 200, a volume of the floating case 220, a density of the liquid detergent, a horizontal area inside the detergent box 150, etc.

Referring to Table 1, when the amount of liquid detergent in the detergent box 150 is little (detergent amount 0%) or less than the reference detergent amount, that is, when the floating device 200 is at the bottom position, the magnetic field change detected by the magnetic field sensor 300 may be approximately 0. When the amount of liquid detergent in the detergent box 150 is greater than or equal to the reference detergent amount and the floating device 200 floats at the floating position, the magnetic field change detected by the magnetic field sensor 300 may be a positive number (greater than 0). When the detergent box 150 is full of liquid detergent (detergent amount 100%), the floating device 200 may be positioned at the maximum position within the detergent box 150, and the magnetic field change detected by the magnetic field sensor 300 may be the maximum change.

TABLE 1

| Magnetic field change (=(bottom | |
|---|---|
| magnetic field intensity) − | Amount of liquid |
| (measured magnetic | detergent in the detergent |
| field intensity | box (%) |
| 0 | 0 or more but less than |
| | reference detergent amount |
| more than 0 but less | reference detergent amount |
| than Maximum change | or more but less than 100 |
| Maximum change | 100 |

As mentioned above, the detergent amount detection device may detect the amount of liquid detergent in the detergent box 150 using the floating device 200 and the magnetic field sensor 300.

The detergent box 150 may include the guide rib 155 provided to guide the movement of the floating device 200. In other words, the guide rib 155 may be provided to guide the movement of the floating case 220. The guide rib 155 may be provided to guide the movement of the floating device 200 with respect to the vertical direction Z due to the buoyancy of the liquid detergent. That is, the guide rib 155 may guide the movement of the floating device 200 between the bottom position and the floating position.

The guide rib 155 may be provided along a periphery of the floating case 220. The guide rib 155 may surround the floating case 220 to form a movement space 155s in which the floating device 200 is provided to be movable in the vertical direction Z. The movement space 155s may extend approximately in the vertical direction Z. The movement space 155s may extend upward from the bottom surface 150a of the detergent box 150.

The guide rib 155 may extend in the vertical direction Z. The guide rib 155 may extend upward from the bottom surface 150a of the detergent box 150. For example, the guide rib 155 may be formed integrally with the bottom surface 150a of the detergent box 150. For example, the guide rib 155 may extend from the bottom surface 150a of the detergent box 150 to a height that is almost parallel to the upper end of the detergent box 150.

For example, the guide rib 155 may include a plurality of guide ribs 155. The plurality of guide ribs 155 may be arranged along the periphery of the floating case 220. The plurality of guide ribs 155 may surround the floating case 220 to form the movement space 155s. As illustrated in FIG. 6, the plurality of guide ribs 155 may be arranged to be spaced apart from each other, or alternatively, the plurality of guide ribs 155 may be connected to each other.

In the same as the plurality of guide ribs 155 disposed in the first receiving chamber 155 illustrated in FIG. 6, the guide ribs 155 may be composed of four guide ribs disposed spaced apart from each other. Alternatively, in the same as the plurality of guide ribs 155 disposed in the second receiving chamber 152 illustrated in FIG. 4, the guide ribs 155 may be composed of three guide ribs disposed spaced apart from each other, and the remaining side of the movement space 155s may be covered by a chamber partition 154.

For example, the detergent box 150 may further be provided with a cap 156 provided to cover the movement space 155s from the upper side. The cap 156 may be coupled to an upper end 155a of each of the plurality of guide ribs 155. The cap 156 may fix the upper end 155a of each of the plurality of guide ribs 155, thereby preventing the upper end 155a of the plurality of guide ribs 155 from moving from the design position, such as spreading outward from the movement space 155s or shrinking inward from the movement space 155s. As a result, the guide rib 155 may more efficiently guide the vertical movement of the floating device 200. For example, the cap 156 may be arranged at a height that is almost parallel to the upper end of the detergent box 150.

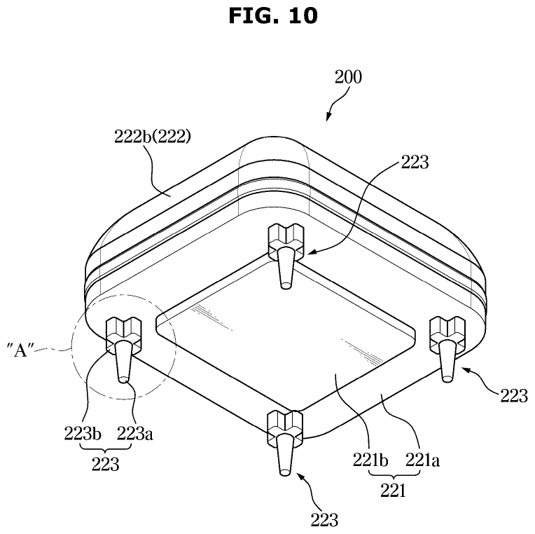

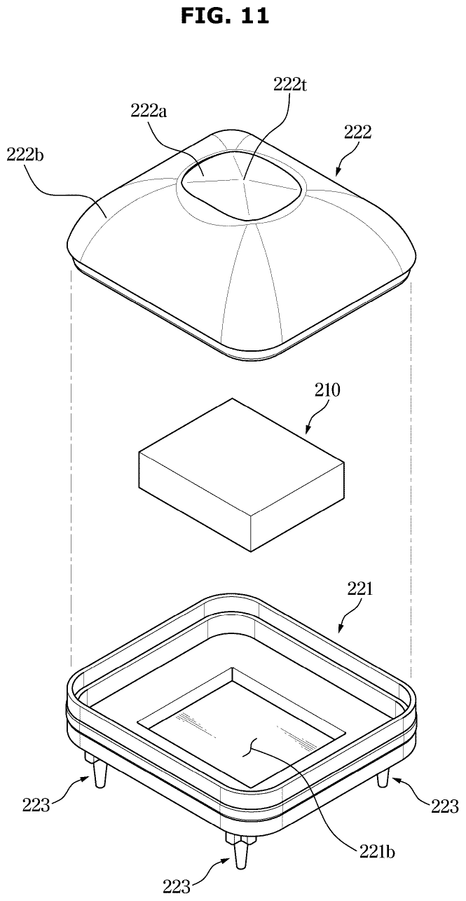

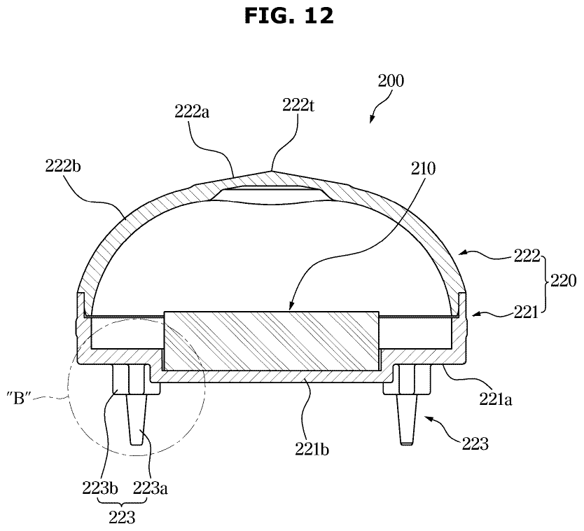

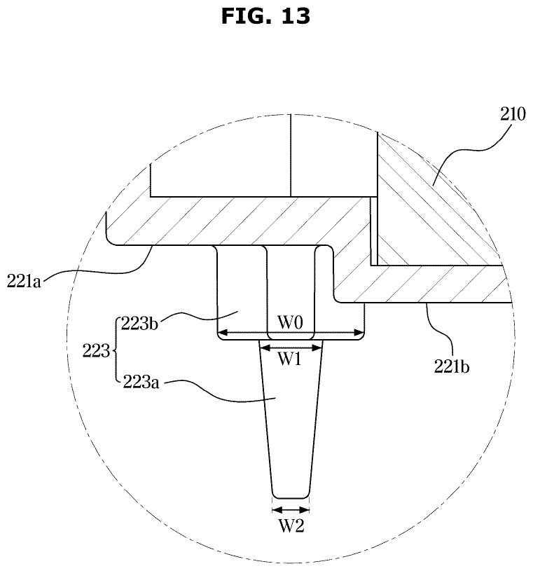

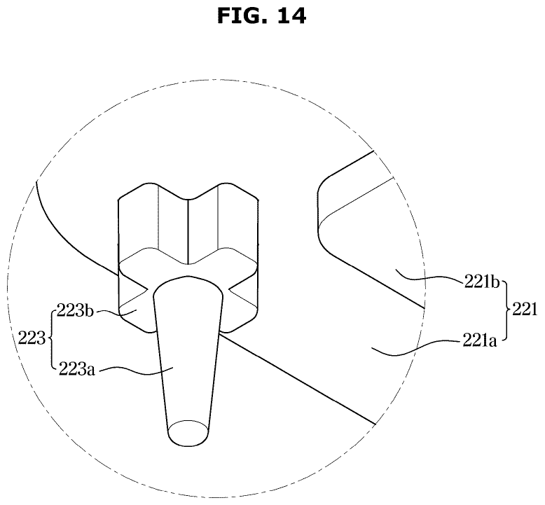

FIG. 9 is a perspective view illustrating the floating device of the detergent supply device of the washing machine according to one embodiment of the present disclosure. FIG. 10 is a bottom perspective view illustrating the floating device of the detergent supply device of the washing machine according to one embodiment of the present disclosure. FIG. 11 is an exploded view of the floating device of the detergent supply device of the washing machine according to one embodiment of the present disclosure. FIG. 12 is a cross-sectional view of the floating device of the detergent supply device of the washing machine according to one embodiment of the present disclosure. FIG. 13 is an enlarged view of part B of FIG. 12. FIG. 14 is an enlarged view of part A of FIG. 10.

Referring to FIGS. 9 to 14, the floating device 200 included in the detergent supply device 100 of the washing machine 1 according to one embodiment of the present disclosure may include the magnet 210 and the floating case 220 provided to accommodate the magnet 210.

The floating case 220 may include a base 221 provided to support the magnet 210. The base 221 may form a portion of the exterior of the floating case 220. The base 221 may form at least a portion of the lower exterior of the floating case 220.

The base 221 may support the magnet 210 from the lower side. The magnet 210 may be mounted on the base 221. The base 221 may include a mounting portion 221b on which the magnet 210 is mounted and supported.

For example, the mounting portion 221b may be formed to allow at least a portion of the magnet 210 to be inserted and mounted. The mounting portion 221b may be formed in a concave groove shape to allow at least a portion of the magnet 210 to be inserted thereinto. The mounting portion 221b may have a shape that substantially corresponds to the magnet 210. The magnet 210 may be fixed to the base 221 by being mounted on the mounting portion 221b.

As the magnet 210 is positioned close to the magnetic field sensor 300 located on the lower side of the floating device 200, the mounting portion 221b may be formed closer to the bottom surface 150a of the detergent box 150 than other portions of the base 221. For example, the base 221 may include a leg connecting portion 221a to which the leg 223 described below is connected, and the mounting portion 221b may protrude to be closer to the bottom surface 150a of the detergent box 150 than the leg connecting portion 221a. As described below, in order to prevent the base 221 from being stuck to the bottom surface 150a of the detergent box 150 due to the liquid detergent, it is not appropriate for the base 221 to be positioned close to the bottom surface 150a of the detergent box 150 as a whole. Therefore, among the base 221, the mounting portion 221b on which the magnet 210 is mounted may be positioned closer to the bottom surface 150a of the detergent box 150 than the leg connecting portion 221a.

However, the present disclosure is not limited thereto, and the magnet 210 may be supported on the base 221 by various structures, and may be fixed to the base 221 by various structures. As shown in FIGS. 9 to 14, the magnet 210 may be directly supported on the base 221, or alternatively, may be indirectly supported on the base 221.

The floating case 220 may include a cover 222 provided to cover the magnet 210 from the upper side. The cover 222 may form a portion of the exterior of the floating case 220. The cover 222 may form at least a portion of the upper exterior of the floating case 220.

The cover 222 may cover the base 221. The cover 222 may cover the base 221 from the upper side. The cover 222 may be coupled to the base 221 to cover the base 221 and the magnet 210 mounted on the base 221. The base 221 and the cover 222 may be coupled to each other to form an accommodation space for accommodating the magnet 210 on the inside. For example, the cover 222 and the base 221 may be coupled by coupling an edge of the cover 222 and an edge of the base 221 to each other. For example, the cover 222 may be coupled to an upper portion of the base 221. For example, the cover 222 and the base 221 may be coupled to each other as a lower end of the cover 222 and an upper end of the base 221 are engaged and tight-fitted. Alternatively, the cover 222 and the base 221 may be formed integrally with each other.

Wit the structure, the floating case 220 may support the magnet 210, and when the floating case 220 moves within the detergent box 150 due to the buoyancy of the liquid detergent, the magnet 210 may also move together.

In order for the floating device 200 to easily float by the liquid detergent, the volume of the floating case 220 may need to be designed to be large, and in particular, it is appropriate that a horizontal area of the base 221 is designed to be large.

Meanwhile, when the base 221 with a large horizontal area comes into direct contact with the bottom surface 150a of the detergent box 150 in a state in which the floating device 200 is positioned at the bottom position, there is a possibility that the liquid detergent located at a contact surface between the floating case 220 and the bottom surface 150a of the detergent box 150 solidifies and cause the floating case 220 to become stuck to the bottom surface 150a of the detergent box 150 because the contact surface area is large. In this case, the floating device 200 may be prevented from moving within the detergent box 150, and thus an error may occur when the detergent amount detection device detects the amount of liquid detergent within the detergent box 150.

Therefore, in order to reduce the contact area between the bottom surface 150a of the detergent box 150 and the floating case 220, the floating case 220 may include the leg 223 provided to be supported on the bottom surface 150a of the detergent box 150 when the position of the floating case 220 in the vertical direction Z within the detergent box 150 is the lowest, that is, when the floating device 200 is at the bottom position. That is, when the floating device 200 is at the bottom position, the leg 223 may come into contact with the bottom surface 150a of the detergent box 150, and thus the floating device 200 may be supported by the bottom surface 150a of the detergent box 150.

The leg 223 may extend from the base 221. The leg 223 may extend from the base 221 toward the bottom surface 150a of the detergent box 150 so as to be in contact with the bottom surface 150a of the detergent box 150 when the floating device 200 is positioned at the bottom position. The base 221 may include the leg connecting portion 221a to which the leg 223 is connected, and the leg 223 may extend downwardly from the leg connecting portion 221a. For example, the leg connecting portion 221a may be provided on a lower surface of the base 221 facing the bottom surface 150a of the detergent box 150, and the leg 223 may extend downwardly from the lower surface of the base 221. For example, the leg connecting portion 221a may be provided at a position adjacent to the edge of the base 221. For example, the leg connecting portion 221a may be provided further outward from the edge than the mounting portion 221b. However, the position at which the leg 223 is connected to the base 221 is not limited thereto.

For example, the leg 223 and the base 221 may be formed integrally.

The base 221 may be spaced apart from the bottom surface 150a of the detergent box 150. Because the floating case 220 is mounted on the bottom surface 150a of the detergent box 150 by the legs 223 at the bottom position, the lower surface of the base 221 may be positioned spaced upward from the bottom surface 150a of the detergent box 150 without being in direct contact with the bottom surface 150a of the detergent box 150.

In order to prevent the floating case 220 from being stuck to the bottom surface 150a of the detergent box 150, a horizontal area of the leg 223 may be less than the horizontal area of the base 221. Accordingly, even when the floating device 200 is at the bottom position, an area in which the leg 223 comes into contact with the bottom surface 150a of the detergent box 150 is sufficiently small and thus the floating case 220 may be effectively prevented from being stuck to the bottom surface 150a of the detergent box 150.

In order to more efficiently prevent the floating case 220 from being stuck to the bottom surface 150a of the detergent box 150, it is appropriate that a ratio of the horizontal area of the lower surface of the leg 223 to the horizontal area of the lower surface of the base 221 be 1/1000 or less, but the ratio of the areas is not limited thereto.

The leg 223 may be provided in such a way that a horizontal width of a lower end of the leg 223 that is in contact with the bottom surface 150a of the detergent box 150 is less than a horizontal width of an upper end of the leg 223 adjacent to the base 221. With this configuration, when the floating device 200 is at the bottom position, the area of the lower end of the leg 223 that is in contact with the bottom surface 150a of the detergent box 150 may be reduced while the area of the upper end adjacent to the base 221 is increased. Accordingly, it is possible to implement a structure in which the base 221 is stably supported by the leg 223.

Particularly, as illustrated in FIGS. 13 and 14, at least a portion of the leg 223 may be formed in such a way that the horizontal area thereof decreases away from the base 221. The leg 223 may include an extending portion 223a, and a horizontal area of the extending portion 223a may decrease away from the base 221. In other words, a horizontal width w2 of the lower end of the extending portion 223a may be less than a horizontal width w1 of the upper end of the extending portion 223a. At this time, the lower end of the extending portion 223a may be a portion that comes into contact with the bottom surface 150a of the detergent box 150 when the floating device 200 is at the bottom position.

The leg 223 may include the extending portion 223a, and a reinforcing portion 223b disposed between the extending portion 223a and the base 221 to reinforce a rigidity of the extending portion 223a. The reinforcing portion 223b may connect the extending portion 223a and the base 221. The reinforcing portion 223b may have a shape of a rib that protrudes outwardly on the upper side of the extending portion 223a. Particularly, the reinforcing portion 223b may be formed as a plurality of rib shapes that protrude outwardly in a horizontal direction from a central axis parallel to the vertical direction Z on the upper side of the extending portion 223a. For example, the reinforcing portion 223b may have a cross-section in the horizontal direction that is approximately in the shape of a cross.

The extending portion 223a may extend downward from the reinforcing portion 223b. For example, the extending portion 223a may have a shape in which a horizontal width decreases from an upper end adjacent to the reinforcing portion 223b toward a lower end opposite thereto.

A horizontal width w0 of the reinforcing portion 223b may be greater than the horizontal width of the extending portion 223a. The horizontal width w0 of the reinforcing portion 223b may be greater than the horizontal width w1 of the upper end of the extending portion 223a. For example, the reinforcing portion 223b may have a constant width w0 as illustrated in FIG. 13, but is not limited thereto.

For example, the base 221, the reinforcing portion 223b, and the extending portion 223a may be formed integrally.

Unlike the above-mentioned description, the leg 223 may have various shapes to support the base 221.

The floating case 220 may include the plurality of legs 223. The plurality of legs 223 may be arranged spaced apart from each other. As a result, the contact area between the floating case 220 and the bottom surface 150a of the detergent box 150 may be reduced while the floating case 220 is stably supported.

For example, as illustrated in FIGS. 9 to 14, the floating case 220 may include four legs 223, but the number of legs 223 provided in the floating case 220 is not limited to that illustrated in FIGS. 9 to 14.

The cover 222 of the floating case 220 may include inclined portions 222a and 222b to prevent liquid detergent, etc. from remaining on the upper surface of the cover 222. The inclined portions 222a and 222b may form at least a portion of the upper exterior of the floating case 220. The inclined portions 222a and 222b may be formed to be inclined with respect to the horizontal direction of the cover 222. The inclined portions 222a and 222b may be formed to be inclined so as to extend downwardly from the center of the cover 222 toward the outside in the horizontal direction. The inclined portions 222a and 222b may be inclined downward toward the outside of the cover 222. The inclined portions 222a and 222b may extend from an upper end 222t of the cover 222 toward the base 221. The liquid detergent on the upper surface of the cover 222 may flow downward along the inclined portions 222a and 222b and move to the outside of the floating case 220.

Particularly, the upper surface of the cover 222 may include a conical portion 222a. The conical portion 222a may extend from the upper end 222t of the cover 222 toward the base 221. In other words, the conical portion 222a may be formed between the upper end 222t of the cover 222 and the base 221. The conical portion 222a may have a shape in which a horizontal width is reduced toward the upper end 222t of the cover 222. In other words, the conical portion 222a may have a shape in which the horizontal width is increased away from the upper end 222t of the cover 222.

For example, the conical portion 222a may be formed to have a constant inclination in the horizontal direction.

For example, the conical portion 222a may have a cone shape in which the upper end 222t of the cover 222 corresponds to a vertex.

With the structure of the conical portion 222a, the liquid detergent on the conical portion 222a may flow downward along the conical portion 222a and may be efficiently moved to the outside of the floating case 220.

In addition, the upper surface of the cover 222 may include a curved portion 222b. The curved portion 222b may include a curved shape in which an angle of inclination with respect to the horizontal direction gradually increases from the upper portion to the lower portion. The curved portion 222b may be formed as a curved shape that is convex upward. The curved portion 222b may be formed to have approximately a part of a dome shape.

Particularly, the curved portion 222b may be arranged between the conical portion 222a and the base 221. The curved portion 222b may extend from the conical portion 222a toward the base 221. The curved portion 222b may extend from a lower end of the conical portion 222a toward the base 221. The curved portion 222b may be formed in such a way that the angle of inclination with respect to the horizontal direction gradually increases from the conical portion 222a toward the base 221. The curved portion 222b may be formed in such a way that the angle of inclination with respect to the horizontal direction increases toward the outside.

With the structure of the curved portion 222b, the liquid detergent on the curved portion 222b may flow downward along the curved portion 222b and may be efficiently moved to the outside of the floating case 220.

In addition, because the curved portion 222b forms an inclined surface while also having an upwardly convex curved shape, sufficient space may be secured to accommodate the magnet 210 inside the floating case 220.

With the shape of the cover 222, liquid detergent, etc. may be prevented from remaining on the upper portion of the floating case 220. Accordingly, the floating device 200 may rise efficiently by the buoyancy of the liquid detergent.

However, the shape of the cover 222 including the inclined portions 222a and 222b is not limited to that described above. For example, the upper surface of the cover 222 may have the shape of the conical portion 222a as a whole without including the curved portion 222b. Alternatively, the upper surface of the cover 222 may have the shape of the curved portion 222b as a whole without including the conical portion 222a. Alternatively, the upper surface of the cover 222 may have an inclined structure of various shapes such as a square pyramid or a triangular pyramid.

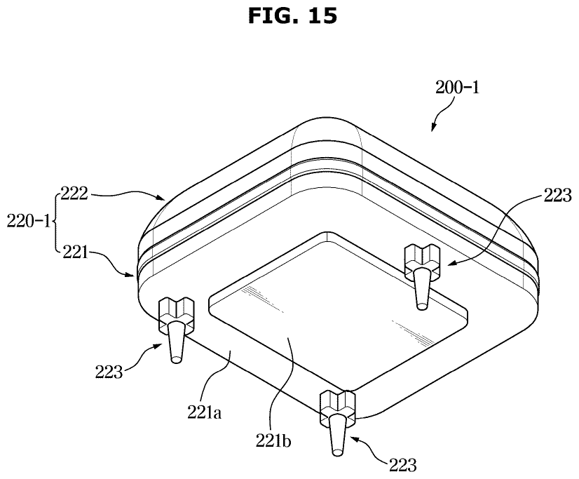

FIG. 15 is a view illustrating a floating device of a detergent supply device of a washing machine according to one embodiment of the present disclosure.

As for describing a floating device 200-1 of a detergent supply device 100 of a washing machine 1 according to one embodiment of the present disclosure with reference to FIG. 15, the same configuration as that of the embodiments illustrated in FIGS. 1 to 14 may be given the same reference numerals and a description thereof may be omitted.

Referring to FIG. 15, the floating device 200-1 of the detergent supply device 100 of the washing machine 1 according to one embodiment of the present disclosure may include three legs 223.

That is, in the floating case 220-1 of the floating device 200-1, the three legs 223 spaced apart from each other may extend from a base 221. When the floating device 200-1 is at a bottom position, the three legs 223 may come into contact with a bottom surface 150-1 of a detergent box 150. When the floating device 200-1 is at the bottom position, the floating device 200-1 may be supported by the three legs 223.

When the number of legs 223 is three as mentioned above, the floating device 200-1 may be stably mounted on the bottom surface 150a of the detergent box 150, while a contact area between the floating case 220-1 and the bottom surface 150a of the detergent box 150 is reduced.

In addition, even when the floating case 220-1 is tilted relative to the bottom surface 150a of the detergent box 150 when the floating device 200-1 is at the bottom position, all three legs 223 may be in contact with the bottom surface 150a. Accordingly, the floating device 200-1 may be stably supported on the bottom surface 150a of the detergent box 150.

It is appropriate that the three legs 223 are arranged such in a way that a distance between any two legs 223 among the three legs 223 is substantially constant.

Unlike the embodiment illustrated in FIGS. 9 to 15, the legs 223 provided on the floating case 220 or 220-1 may have various shapes that allow the floating case 220 or 220-1 to be supported on the bottom surface 150a of the detergent box 150 while having a narrower area than the horizontal area of the base 221. For example, the legs 223 may be formed in the shape of a plurality of long and thin ribs protruding downward from the base 221.

FIG. 16 is an enlarged view of some components, such as a detergent box including a guide rib, a floating device, and a magnetic field sensor, in a detergent supply device of a washing machine according to one embodiment of the present disclosure.

As for describing a floating device 200-2 of a detergent supply device 100 of a washing machine 1 according to one embodiment of the present disclosure with reference to FIG. 16, the same configuration as that of the embodiments illustrated in FIGS. 1 to 14 may be given the same reference numerals and a description thereof may be omitted.

Referring to FIG. 16, according to one embodiment of the present disclosure, a structure such as the leg 223 described in the preceding embodiments may not be provided in the floating case 200-2 of the floating device 200-2. Accordingly, a base 221 may be positioned at the bottommost in each part of the floating case 200-2. Accordingly, when the floating device 200-2 is at a bottom position, the base 221 of the floating case 220-2 may come into contact with the bottom surface 150a of the detergent box 150, which may cause a difficulty in that a contact area between the floating case 220-2 and the detergent box 150 increases.

In order to prevent the floating case 220-2 from being stuck to the detergent box 150 by the contact between the base 221 of the floating case 220-2 and the bottom surface 150a of the detergent box 150, the detergent box 150 may include a support portion 155b provided to support the floating case 220-2.

The support portion 155b may support the floating case 220-2 to allow the floating case 220-2 to be spaced apart from the bottom surface 150a of the detergent box 150 when a vertical position of the floating case 220-2 within the detergent box 150 is the lowest, that is, when the floating device 200-2 is at the bottom position. The support portion 155b may be provided to support a lower portion of the floating case 220-2. The support portion 155b may be provided at the lower portion of the detergent box 150 to support the lower portion of the floating case 220-2. When the floating device 200-2 is at the bottom position, the support portion 155b may support the lower portion of the base 221 of the floating case 220-2.

For example, the support portion 155b may be provided to support a portion other than a mounting portion 221b in the base 221 of the floating case 220-2.

As illustrated in FIG. 16, the support portion 155b may be included in a guide rib 155. The support portion 155b may protrude from a lower portion of the guide rib 155. The support portion 155b may protrude from the guide rib 155 toward a movement space 155s. The support portion 155b may extend in the horizontal direction from a portion extending in the vertical direction Z of the guide rib 155.

For example, the support portion 155b may be positioned at a predetermined distance upward from the bottom surface 150a of the detergent box 150.

For example, when the detergent box 150 includes a plurality of guide ribs 155 as described above, each of the plurality of guide ribs 155 may include a support portion 155b. For example, the plurality of support portions 155b provided on the plurality of guide ribs 155 may be arranged to be spaced apart from each other in the horizontal direction.

With the above-mentioned structure of the support portion 155b, the floating case 220-2 may not come into contact with the bottom surface 150a of the detergent box 150 at the bottom position. In addition, when the floating device 200-2 is positioned at the bottom position, an area in which the floating case 220-2 comes into contact with the support portion 155b is less than a horizontal area of the base 221 of the floating case 220-2, and thus the floating case 220-2 may be effectively prevented from being stuck to the detergent box 150.

Alternatively, unlike the embodiment of FIG. 16, according to one embodiment, the floating case 220-2 without the leg 223 may be supported by one or more supporting protrusions extending upward from the bottom surface 150a of the detergent box 150. The one or more supporting protrusions extending from the bottom surface 150a of the detergent box 150 may be formed to allow a width of the protrusion to be smaller than the horizontal area of the base 221. With this structure, the floating case 220-2 may be prevented from being stuck to the detergent box 150.

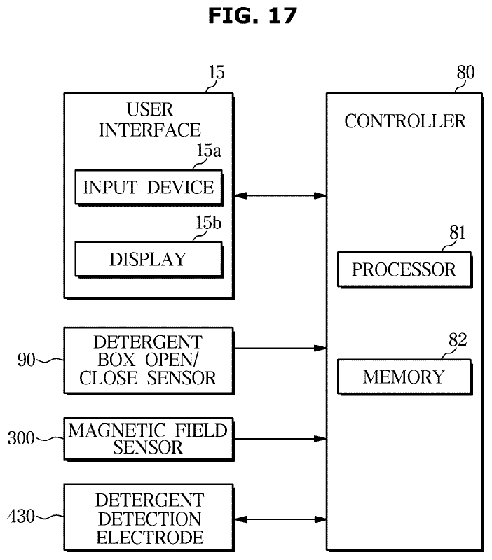

FIG. 17 is a block diagram illustrating some components of the washing machine according to one embodiment of the present disclosure.

Referring to FIG. 17, the washing machine 1 according to one embodiment of the present disclosure may include a user interface 15. The user interface 15 may be provided by the control panel 15 (refer to FIG. 1) described above.

The user interface 15 may include an input device 15a for receiving a user input. The input device 15a may receive setting values related to the operation of the washing machine 1 from the user or may receive various control commands.

The types of user input obtained through the input device 15a may include turning the power of the washing machine 1 on/off, starting/stopping the operation of the washing machine 1, and setting the operation of the washing machine 1.

The input device 15a may include various types of input devices such as a tact switch, a push switch, a slide switch, a toggle switch, a micro switch, or a touch switch.

The input device 15a may be electrically connected to a controller 80. The input device 15a may obtain a user input and output an electrical signal (voltage or current) corresponding to the user input to the controller 80. The controller 80 may receive the user input based on the output signal of the input device 15a.

The user interface 15 may include a display 15b for displaying information related to the operation or status of the washing machine 1. The display 15b may be electrically connected to the controller 80 and may be provided to display information about the operation or status of the washing machine 1 based on a control signal received from the controller 80.

The information related to the operation or status of the washing machine 1 displayed by the display 15b may include setting information, operation time (or remaining time until operation ends), information on the remaining amount of detergent, information on the occurrence of various errors, etc.

The display 15b may be provided to provide information to a user by including a light emitting diode (LED) panel, an organic light emitting diode (OLED) panel, or a liquid crystal display (LCD) panel.

Further, the display 15b may include a touch screen including a touch pad provided to detect a user's touch. The touch screen may display settings or control commands that can be selected by a user, and may receive settings or control commands based on a user's touch input.

The type of the user interface 15 included in the washing machine 1 according to one embodiment of the present disclosure is not limited thereto, and may include various types of user interfaces such as a voice UI using sound, including a speaker/microphone module, etc.

The washing machine 1 may include a detergent box open/close sensor 90. The detergent box open/close sensor 90 may detect whether the detergent box 150 is inserted into the main body 10 or withdrawn from the main body 10 (i.e., whether the detergent box 150 is opened or closed). The detergent box open/close sensor 90 may output an electrical signal indicating whether the detergent box 150 is inserted into the main body 10 or withdrawn from the main body 10. The detergent box open/close sensor 90 may be electrically connected to the controller 80, and the controller 80 may determine whether the detergent box 150 is inserted into the main body 10 or withdrawn from the main body 10 based on an electrical signal received from the detergent box open/close sensor 90. The detergent box open/close sensor 90 may include various types of known sensors, such as a Hall sensor and a reed switch.

The washing machine 1 may include the magnetic field sensor 300 described above. The magnetic field sensor 300 may detect a magnetic field of the magnet 210 of the floating device 200. The magnetic field sensor 300 may output an electrical signal corresponding to the magnetic field of the magnet 210. The magnetic field sensor 300 may be electrically connected to the controller 80, and the controller 80 may determine an amount of liquid detergent in the detergent box 150 based on an electrical signal received from the magnetic field sensor 300. The controller 80 may control the user interface 15 to output information on a remaining amount of liquid detergent in the detergent box based on the electrical signal received from the magnetic field sensor 300.

The washing machine 1 may include a detergent detection electrode 430. For example, the detergent detection electrode 430 may be disposed in the detergent pump 400 described above. The detergent detection electrode 430 may be configured to detect liquid detergent in the detergent box 150. The detergent detection electrode 430 may be electrically connected to the controller 80. When a voltage is applied to the detergent detection electrode 430 by a control signal of the controller 80, the detergent detection electrode 430 may come into contact with liquid detergent and the circuit of the detergent detection electrode 430 may be energized. Accordingly, a signal indicating that the circuit of the detergent detection electrode 430 is energized may be transmitted to the controller 80. The controller 80 may detect that detergent is stored in the detergent box 150 based on the energization of the circuit of the detergent detection electrode 430.

A detailed description of the detergent detection electrode 430 will be described later. The washing machine 1 may include the controller 80 configured to control various components of the washing machine 1.

The controller 80 may include a processor 81 configured to generate a control signal regarding the operation of the washing machine 1, and a memory 82 provided to store a program, application, instruction and/or data for the operation of the washing machine 1. The processor 81 and the memory 82 may be implemented as separate semiconductor devices or may be implemented as a single semiconductor device. In addition, the controller 80 may include a plurality of processors or a plurality of memories.

The processor 81 may include an arithmetic circuit, a memory circuit, and a control circuit. The processor 81 may include one chip or may include a plurality of chips. In addition, the processor 81 may include one core or may include a plurality of cores.

The processor 81 may be electrically connected to the memory 82. The processor 81 may process data and/or signals using a program provided from the memory 82, and may transmit control signals to each component of the washing machine 1 based on the processing result. Each component of the washing machine 1 may be operated based on the control signal of the processor 81.

The memory 82 may store various programs and data required for the control, and may temporarily store temporary data generated during the control.

The memory 82 may include volatile memory, such as Static Random Access Memory (S-RAM) and Dynamic Random Access Memory (D-RAM), and nonvolatile memory, such as Read Only Memory (ROM) and Erasable Programmable Read Only Memory (EPROM). The memory 82 may include one memory element or may include a plurality of memory elements.

The washing machine 1 may include at least one controller 80. The controller 80 may be composed of a plurality of control modules or may be composed of an integrated control module. For example, the controller 80 composed of an integrated control module may be electrically connected to each of the user interface 15, the detergent box open/close sensor 90, the magnetic field sensor 300, and the detergent detection electrode 430. Alternatively, each of the controllers 80 composed of a plurality of separate control modules may be electrically connected to each of the user interface 15, the detergent box open/close sensor 90, the magnetic field sensor 300, and the detergent detection electrode 430.

The configuration of the washing machine 1 described above with reference to FIG. 17 is merely an example of a part of the configuration of the washing machine 1 according to one embodiment of the present disclosure, and the present disclosure is not limited thereto.

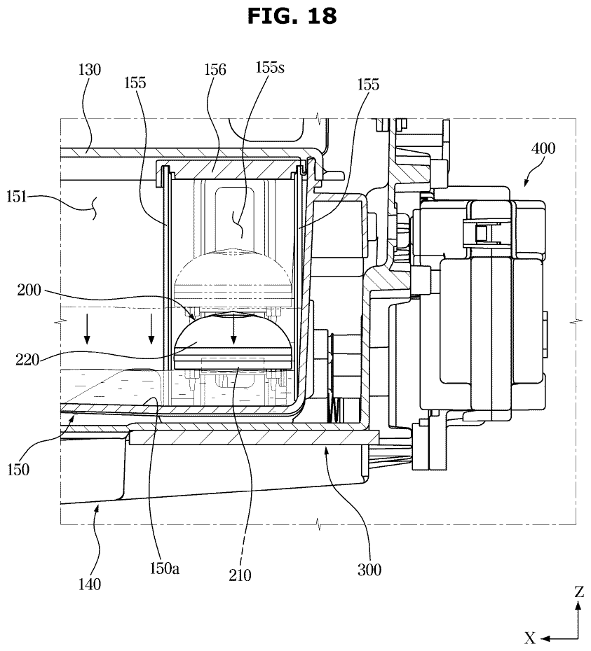

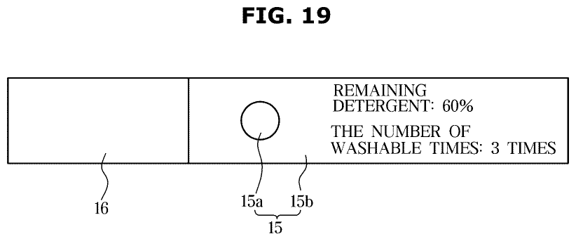

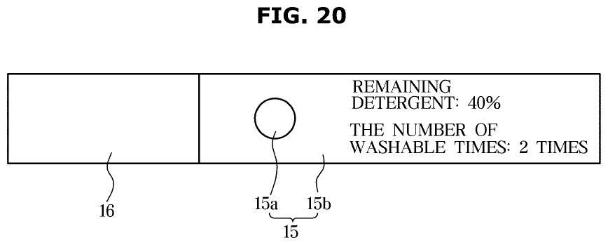

FIG. 18 is a view illustrating the floating device that descends as an amount of detergent remaining in the detergent box included in the detergent supply device of the washing machine according to one embodiment of the present disclosure decreases. FIG. 19 is a view illustrating an example of a state in which a display of the washing machine according to one embodiment of the present disclosure outputs information on an amount of detergent remaining in the detergent box detected by the floating device and the magnetic field sensor. FIG. 20 is a view illustrating an example of a state in which the display of the washing machine according to one embodiment of the present disclosure outputs information on an amount of detergent remaining in the detergent box detected by the floating device and the magnetic field sensor as an amount of detergent remaining in the detergent box is reduced compared to the state of FIG. 19.

Referring to FIGS. 18 to 20, the washing machine 1 according to one embodiment of the present disclosure may output information on a remaining amount of liquid detergent in the detergent box 150 through the user interface 15. The user interface 15 may output information on the remaining amount of liquid detergent in the detergent box 150 based on an electrical signal output from the magnetic field sensor 300.

The magnetic field sensor 300 may detect the magnetic field of the magnet 210 of the floating device 200 and output an electrical signal corresponding thereto as described above. The controller 80 may be electrically connected to the magnetic field sensor 300 and receive the electrical signal output from the magnetic field sensor 300.

The controller 80 may output information on the remaining amount of liquid detergent in the detergent box 150 to the user interface 15 based on the electrical signal received from the magnetic field sensor 300. Particularly, the controller 80 may control the display 15b to output information on the remaining amount of liquid detergent in the detergent box 150 based on the electrical signal received from the magnetic field sensor 300.

Information on the remaining amount of liquid detergent in the detergent box 150 provided to a user through the user information 15 may include a ratio of the amount of liquid detergent stored in the detergent box 150, the expected number of times that the washing process is performed using the remaining liquid detergent, etc.

For example, as the washing machine 1 repeatedly performs the washing process, the remaining amount of liquid detergent stored in the detergent box 150 may decrease. When the remaining amount of liquid detergent decreases, the height of the floating device 200 in the detergent box 150 may be lowered as shown in FIG. 18, and the intensity of the magnetic field detected by the magnetic field sensor 300 may vary depending on the height of the floating device 200.

When the electrical signal output from the magnetic field sensor 300 changes, the display 15b may output changed information on the remaining amount of liquid detergent. For example, as shown in FIGS. 19 and 20, when the remaining amount of liquid detergent in the detergent box 150 decreases and the height of the floating device 200 is lowered, the display 15b may output information corresponding to the remaining amount of liquid detergent after the decrease.

The method, in which information on the remaining amount of liquid detergent in the detergent box 150 is provided a user, is not limited thereto, and for example, information on the remaining amount of liquid detergent in the detergent box 150 may be provided in the form of voice information through a microphone module of the washing machine 1. Alternatively, information on the remaining amount of liquid detergent in the detergent box 150 may be provided in the form of communication information as a communication module of the washing machine 1 communicates with an external terminal device of a user or a server device.

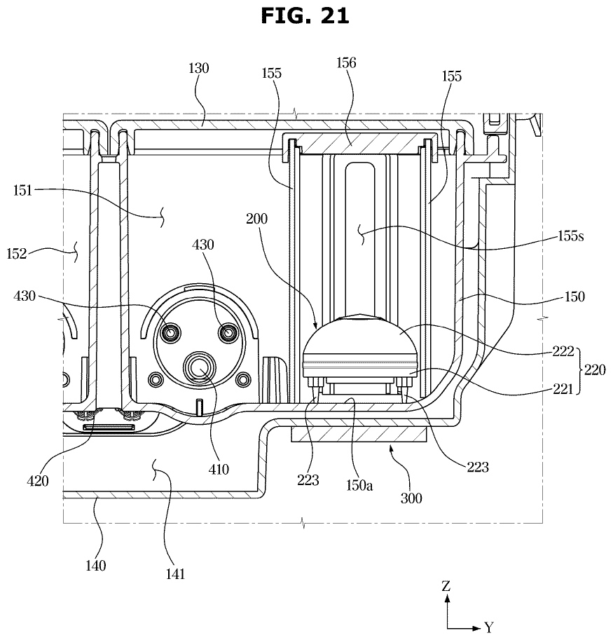

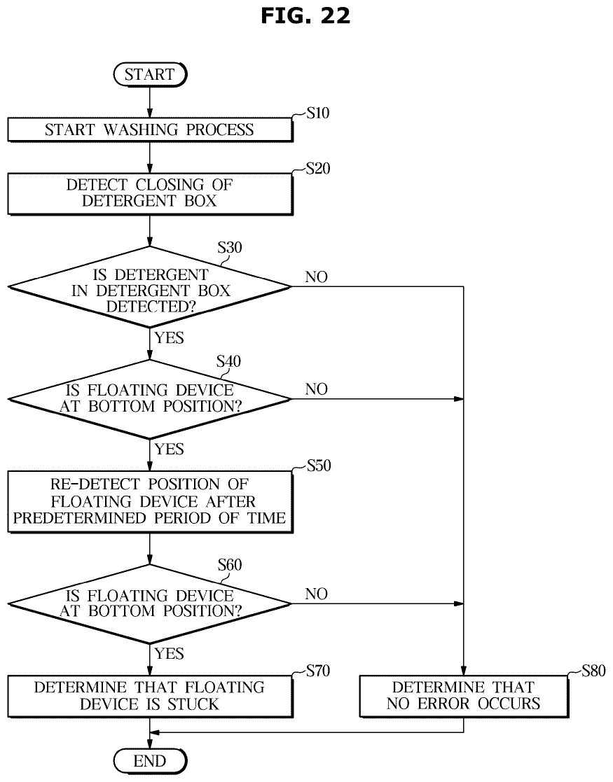

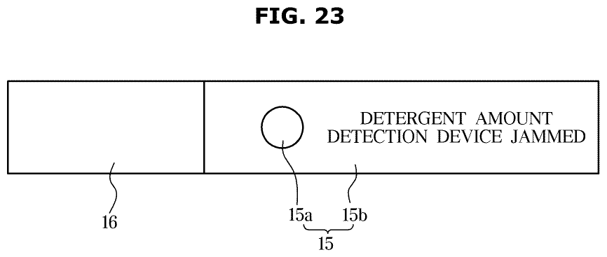

FIG. 21 is a view illustrating the detergent box, the floating device, and a detergent detection electrode of the detergent supply device of the washing machine according to one embodiment of the present disclosure. FIG. 22 is a flowchart illustrating a method for determining whether the floating device is stuck to the detergent box using the floating device, the magnetic field sensor, and the detergent detection sensor of the detergent supply device of the washing machine according to one embodiment of the present disclosure. FIG. 23 is a view illustrating an example of a state in which the display of the washing machine according to one embodiment of the present disclosure outputs information on the floating device being stuck to the detergent box.

Referring to FIGS. 21 to 23, the washing machine 1 according to one embodiment of the present disclosure may be configured to determine whether the floating device 200 is stuck to the bottom surface 150a of the detergent box 150, i.e., whether the floating device 200 is stuck and is prevented from moving.

Particularly, as described above, the detergent supply device 100 of the washing machine 1 may include the detergent detection electrode 430 configured to detect liquid detergent in the detergent box 150. The detergent detection electrode 430 may be provided to detect whether liquid detergent is present in the detergent box 150.

For example, the detergent detection electrode 430 may include a conductive terminal portion through which a current flows, and at least the terminal portion of the detergent detection electrode 430 may be located within the detergent box 150.

For example, the detergent detection electrodes 430 may be provided as a pair. The pair of detergent detection electrodes 430 may be positioned at parallel heights to each other.

When a voltage is applied to the detergent detection electrode 430 in a state in which liquid detergent is stored in the detergent box 150 and the liquid detergent has a sufficient height to be in contact with the detergent detection electrode 430, the circuit of the detergent detection electrode 430 may be energized through the liquid detergent. When the controller 80 performs an operation to detect the presence or absence of liquid detergent in the detergent box 150 by using the detergent detection electrode 430, the controller 80 may apply a voltage to the detergent detection electrode 430. When the circuit of the detergent detection electrode 430 is energized or not after the voltage is applied to the detergent detection electrode 430, the controller 80 may receive an electrical signal corresponding to each case. The circuit of the detergent detection electrode 430 being energized means that a current flows through the detergent detection electrode 430, and the circuit of the detergent detection electrode 430 not being energized means that a current does not flow even though the voltage is applied to the detergent detection electrode 430.

The controller 80 may determine that liquid detergent of a predetermined height or higher is stored in the detergent box 150 based on a voltage being applied to the detergent detection electrode 430 and the circuit of the detergent detection electrode 430 being energized. The meaning of ‘that the liquid detergent is stored in the detergent box 150 at a predetermined height or higher’ means that the liquid detergent is stored in the detergent box 150 at a height of the detergent detection electrode 430 or higher. In this case, the predetermined height may be a height that is greater than or equal to a height of the liquid detergent of the reference detergent amount for the floating device 200 to float.

Conversely, the controller 80 may determine that there is little liquid detergent in the detergent box 150 or a small amount of liquid detergent is stored below the predetermined height based on the voltage being applied to the detergent detection electrode 430 and the circuit of the detergent detection electrode 430 not being energized.

At this time, the controller 80 may determine that the floating case 220 is stuck to the bottom surface 150a of the detergent box 150 based on the detected magnetic field of the magnet 210 corresponding to the magnetic field when the floating device 200 is at the bottom position even when a voltage is applied to the detergent detection electrode 430 and the circuit of the detergent detection electrode 430 is energized based on the electrical signal received from the detergent detection electrode 430 and the electrical signal received from the magnetic field sensor 300. In other words, the controller 80 may determine that the floating case 220 is stuck to the bottom surface 150a of the detergent box 150 based on the liquid detergent in the detergent box 150 being greater than or equal to the predetermined height and the floating case 220 not rising from the bottom surface 150a of the detergent box 150 (i.e., the floating device 200 is at the bottom position).

Meanwhile, in the embodiment of FIG. 21, it is illustrated that the detergent detection electrode 430 is a component of the detergent pump 400 provided in the detergent pump 400, but is not limited thereto. Alternatively, the detergent detection electrode 430 may be provided as a separate component from the detergent pump 400.

Regarding an example of a control method of the washing machine 1, a more detailed description is provided with reference to FIG. 22.

Based on a user input, which is for starting the washing process, being obtained through the user interface 15 such as the input device 15a, the controller 80 of the washing machine 1 may output a control signal for starting the washing process (10). In response to the closing of the detergent box 150 (i.e., the detergent box 150 is inserted into the main body 10) being detected by the detergent box open/close sensor 90 (20), detecting whether liquid detergent of a predetermined height or higher is stored in the detergent box 15 by using the detergent detection electrode 430 may be performed (30). In the detection, the controller 80 may apply a voltage to the detergent detection electrode 430.

In response to the liquid detergent in the detergent box 150 not being detected by the detergent detection electrode 430 (no in 30), it is difficult to determine whether an error occurs caused by the floating device 200 being stuck to the bottom surface 150a of the detergent box 150, and thus the controller 80 may determine that no error occurs (80).

Based on the liquid detergent in the detergent box 150 being detected by the detergent detection electrode 430 (yes in 30), the controller 80 may determine whether the floating device 200 is located at the bottom position via the magnetic field sensor 300 (40). Based on the floating device 200 being at the floating position when the liquid detergent in the detergent box 150 is detected by the detergent detection electrode 430, no error may occur. Therefore, based on the floating device 200 not being at the bottom position (no in 40), the controller 80 may determine that no error occurs (80). Based on the floating device 200 being at the bottom position even when the liquid detergent in the detergent box 150 is detected by the detergent detection electrode 430, it may be assumed that the floating case 220 is stuck to the bottom surface 150a of the detergent box 150. Therefore, based on the floating device 200 being at the bottom position (yes in 40), the controller 80 may determine that the floating case 220 is stuck to the bottom surface 150a of the detergent box 150 (70).

Meanwhile, it may take some time for the floating device 200 to rise by the buoyancy of the liquid detergent after the liquid detergent is put into the detergent box 150 at the predetermined height or higher, and thus in one embodiment, based on the liquid detergent in the detergent box 150 being detected by the detergent detection electrode 430 (yes in 30) and the floating device 200 detected as being at the bottom position by the magnetic field sensor 300 (yes in 40), re-detecting the position of the floating device 200 may be performed using the magnetic field sensor 300 after a predetermined period of time (50). For example, the predetermined period of time may be set to approximately 1 minute, but is not limited thereto. Alternatively, the predetermined period of time may be appropriately set to various times experimentally or empirically.

Based on the floating device 200 not being at the bottom position (no in 60) after re-detecting the position of the floating device 200 (50), the controller 80 may determine that no error occurs (80). Alternatively, based on the floating device 200 being at the bottom position (yes in 60) after re-detecting the position of the floating device 200 (50), the controller 80 may determine that the floating case 220 is stuck to the bottom surface 150a of the detergent box 150 (70).

In response to the occurrence of the error being determined because the floating case 220 is stuck to the bottom surface 150a of the detergent box 150 (70), corresponding subsequent operations may be performed.

For example, referring to FIG. 23, the washing machine 1 according to one embodiment of the present disclosure may output information on whether the floating case 220 is stuck to the bottom surface 150a of the detergent box 150 through the user interface 15. The controller 80 may control the user interface 15 to output information on whether the floating case 220 is stuck to the bottom surface 150a of the detergent box 150 based on the floating case 220 being stuck to the bottom surface 150a of the detergent box 150.

For example, as illustrated in FIG. 23, based on a control signal of the controller 80, the display 15b may display information to inform a user that the floating case 220 is stuck to the bottom surface 150a of the detergent box 150, such as “detergent amount detection device jammed”

In the above, when describing the configurations of the washing machine 1 according to one embodiment of the present disclosure with reference to FIGS. 1 to 23, the detergent amount detection device has been described based on one embodiment in which the detergent amount detection device is disposed in the detergent box 150 provided in the detergent supply device 100 that stores a large amount of detergent and automatically supplies a predetermined amount of detergent during the washing process. However, the present disclosure is not limited thereto, and a detergent amount detection device according to the present disclosure may also be provided in a detergent box of a detergent supply device that requires a user to directly put detergent to be used into the detergent box each time a washing process is performed.

In addition, the detergent amount detection device according to the present disclosure may be applied to various products that use liquid detergent, such as dishwashers, in addition to washing machines 1, so as to detect the amount of liquid detergent.

In addition, the configuration of the detergent amount detection device according to the present disclosure may be correspondingly applied to a liquid level detection device configured to detect various types of liquids other than liquid detergents. For example, the liquid level detection device may be configured to detect a remaining amount of liquid contained in a liquid container. The liquid level detection device may include a floating device configured to be vertically movable according to a height of liquid contained in the liquid container by the buoyancy of the liquid. The liquid container may be provided with a guide rib that guides the movement of the floating device. The floating device may include a magnet and a floating case provided to support the magnet. In addition, a magnetic field sensor may be arranged on one side of the floating device, and the magnetic field sensor may detect a magnetic field by the magnet. As the magnetic field sensor detects the magnetic field by the magnet, the liquid level detection device may detect a remaining amount of liquid contained in the liquid container. The structure of the magnet, the floating case, etc. included in the liquid level detection device may correspond to the structure of the detergent amount detection device in the embodiment of the washing machine 1 described with reference to FIGS. 1 to 23. In addition, the method of outputting information on the remaining liquid amount using the liquid level detection device or the method of determining whether the floating case of the liquid level detection device is stuck to a bottom surface of the liquid container may correspond to the case of the embodiment of the washing machine 1 described with reference to FIGS. 17 to 23.

A washing machine according to one embodiment of the present disclosure may include a tub; a detergent box provided to store liquid detergent to be supplied to the tub; a floating case disposed in the detergent box, configured to move vertically depending on a height of the liquid detergent in the detergent box, and provided to support the magnet; a magnetic field sensor disposed on one side of the floating case and configured to detect a magnetic field generated by the magnet; and a user interface configured to output information on a remaining amount of the liquid detergent in the detergent box based on an electrical signal output from the magnetic field sensor.

The user interface may include a display configured to display information on the remaining amount of the liquid detergent in the detergent box based on an electrical signal output from the magnetic field sensor.

The floating case may include a base provided to support the magnet, and a leg extending from the base toward a bottom surface of the detergent box so as to be supported on the bottom surface of the detergent box in response to a vertical position of the floating case within the detergent box being at the lowest.

A horizontal area of the leg may be less than a horizontal area of the base.

A lower end of the leg in contact with the bottom surface of the detergent box may have a horizontal width that is less than a horizontal width of the upper end of the leg adjacent to the base.

At least a portion of the leg may have the horizontal area that is reduced away from the base.

The floating case may include a base provided to support the magnet, and a cover provided to cover an upper side of the magnet. An upper surface of the cover may include the inclined portion extending from an upper end of the cover toward the base and inclined with respect to the horizontal direction.

The inclined portion may include a conical portion having a horizontal width that is reduced toward the upper end of the cover.

The inclined portion may include a curved portion disposed between the conical portion and the base and having an inclination angle with respect to the horizontal direction that gradually increases from the conical portion toward the base.

The detergent box may include a guide rib provided along a periphery of the floating case and provided to guide movement of the floating case in the vertical direction.

The guide rib may extend upward from the bottom surface of the detergent box.

The guide rib may include the plurality of guide ribs. The plurality of guide ribs may form a movement space in which the floating case moves in the vertical direction. The washing machine may further include a cap provided to cover an upper side of the movement space and provided to fix an upper end of each of the plurality of guide ribs.

The guide rib may include a support portion provided to protrude from a lower portion of the guide rib and provided to support a lower portion of the floating case to allow the floating case to be spaced apart from the bottom surface of the detergent box in response to a vertical position of the floating case within the detergent box being at the lowest.

The washing machine may further include a detergent detection electrode configured to detect liquid detergent in the detergent box, and at least one controller electrically connected to the magnetic field sensor and the detergent detection electrode. The at least one controller may be configured to determine that the floating case is stuck to the detergent box based on liquid detergent in the detergent box being at a predetermined height or higher and based on the floating case not rising within the detergent box.

The at least one controller may be configured to control the user interface to output information on the floating case being stuck to the detergent box based on the floating case being stuck to the detergent box.

A washing machine according to one embodiment of the present disclosure may include: a tub; a detergent box provided to store liquid detergent to be supplied to the tub; a floating device disposed in the detergent box, configured to move between a bottom position closest to a bottom surface of the detergent box and a floating position rising from the bottom position by the buoyancy due to liquid detergent in the detergent box, the floating device including a magnet; a magnetic field sensor disposed below the floating device and configured to detect a magnetic field by the magnet; and a display configured to display information on a remaining amount of the liquid detergent in the detergent box based on an electrical signal output from the magnetic field sensor.

The floating device may further include a base provided to support the magnet and spaced apart from the bottom surface of the detergent box, and a leg extending from the base and provided to come into contact with the bottom surface of the detergent box in response to the floating device being at the bottom position, the leg having a horizontal area less than a horizontal area of the base.

The floating device may further include a base provided to support the magnet, and a cover provided to cover an upper side of the magnet. An upper surface of the cover may include a conical portion formed between an upper end of the cover and the base and having a horizontal width that is increased toward the base; and a curved surface disposed between the conical portion and the base and having an angle of inclination with respect to the horizontal direction that is gradually increased from the conical portion toward the base.

The washing machine may further include a detergent detection electrode configured to detect liquid detergent in the detergent box, and at least one controller electrically connected to the display, the magnetic field sensor and the detergent detection electrode. The at least one controller may be configured to control the display to output information on the floating device being stuck to the detergent box based on liquid detergent in the detergent box being at a predetermined height or higher and based on the floating case not rising within the detergent box.

A liquid level detection device according to one embodiment of the present disclosure may include a floating case configured to move vertically in a liquid container depending on a height of liquid contained in the liquid container, and provided to support a magnet; a magnetic field sensor disposed on one side of the floating case and configured to detect a magnetic field by the magnet; and a user interface configured to output information on a remaining amount of the liquid contained in the liquid container based on an electrical signal output from the magnetic field sensor.

As is apparent from the above description, a washing machine may efficiently detect a remaining amount of liquid detergent in a detergent box by including a floating device configured to move vertically depending on a height of liquid detergent in the detergent box, and a magnetic field sensor arranged on one side of the floating device. In addition, a liquid level detection device may efficiently detect a remaining amount of liquid in a liquid container by including a floating device configured to move vertically depending on a height of liquid in the liquid container, and a magnetic field sensor arranged on one side of the floating device.

Further, a floating device of a washing machine may include a base provided to support a magnet, and a leg extending from the base to be in contact with a bottom surface of a detergent box and having a narrower area than the base, so as to prevent the floating device from being stuck to the bottom surface of the detergent box caused by solidification of liquid detergent. In addition, a floating device of a liquid level detection device may include a base provided to support a magnet, and a leg extending from the base to be in contact with a bottom surface of a liquid container and having a narrower area than the base, so as to prevent the floating device from being stuck to the bottom surface of the liquid container caused by solidification of liquid detergent.

Further, a floating device of a washing machine may include a cover provided in an upper portion thereof and having an inclined shape, thereby preventing liquid detergent from remaining on the upper portion of the floating device. In addition, a floating device of a liquid level detection device may include a cover provided in an upper portion thereof and having an inclined shape, thereby preventing liquid from remaining on the upper portion of the floating device.

Further, a detergent box of a washing machine may include a guide rib provided to guide movement of a floating device in the detergent box, and thus the floating device may efficiently move up and down in the detergent box. In addition, a liquid container of a liquid level detection device may include a guide rib provided to guide movement of a floating device in the liquid container, and thus the floating device may efficiently move up and down in the liquid container.

Further, a washing machine may determine whether a floating device is stuck to a bottom surface of a detergent box by using a detergent detection electrode configured to detect the presence or absence of detergent in the detergent box. In addition, a liquid level detection device may determine whether a floating device is stuck to a bottom surface of a liquid container by using a liquid detection electrode configured to detect the presence or absence of liquid in the liquid container.

Additional aspects of the disclosure will be set forth in part in the description which follows and, in part, will be obvious from the description, or may be learned by practice of the disclosure.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored. For example, there may be a Read Only Memory (ROM), a Random Access Memory (RAM), a magnetic tape, a magnetic disk, a flash memory, and an optical data storage device.

Storage medium readable by machine, may be provided in the form of a non-transitory storage medium. “Non-transitory storage medium” means that the storage medium is a tangible device and does not contain a signal (e.g., electromagnetic wave), and this term includes a case in which data is semi-permanently stored in a storage medium and a case in which data is temporarily stored in a storage medium. For example, “non-transitory storage medium” may include a buffer in which data is temporarily stored.

The method according to the various disclosed embodiments may be provided by being included in a computer program product. Computer program products may be traded between sellers and buyers as commodities. Computer program products are distributed in the form of a device-readable storage medium (e.g., compact disc read only memory (CD-ROM)), or are distributed directly or online (e.g., downloaded or uploaded) between two user devices (e.g., smartphones) through an application store (e.g., Play Store™). In the case of online distribution, at least a portion of the computer program product (e.g., downloadable app) may be temporarily stored or created temporarily in a device-readable storage medium such as the manufacturer's server, the application store's server, or the relay server's memory.

While the present disclosure has been particularly described with reference to exemplary embodiments, it should be understood by those of skilled in the art that various changes in form and details may be made without departing from the spirit and scope of the present disclosure.

1. A washing machine comprising:
a tub;
a detergent box configured to store liquid detergent to be supplied to the tub;
a magnet generating a magnetic field;
a floating case in the detergent box and configured to move vertically in the detergent box depending on a height of the liquid detergent stored in the detergent box, the floating case configured to support the magnet;
a magnetic field sensor at a side of the floating case and configured to detect the magnetic field generated by the magnet and output an electrical signal indicative of an amount of the liquid detergent stored in the detergent box based on the detected magnetic field; and
a user interface configured to output information on the amount of the liquid detergent stored in the detergent box based on the electrical signal output from the magnetic field sensor.

2. The washing machine of claim 1, wherein the user interface includes a display configured to display the information.

3. The washing machine of claim 1, wherein
the floating case includes:
a base supporting the magnet, and
a leg extending from the base toward a bottom surface of the detergent box so that, with a vertical position of the floating case being at a lowest position in the detergent box, the leg is supported on the bottom surface of the detergent box.

4. The washing machine of claim 3, wherein a horizontal area of the leg is less than a horizontal area of the base.

5. The washing machine of claim 4, wherein a lower end of the leg that contacts the bottom surface of the detergent box when the vertical position of the floating case is at the lowest position has a horizontal width that is less than a horizontal width of an upper end of the leg that is adjacent to the base.

6. The washing machine of claim 4, wherein at least a portion of the leg has a horizontal area that decreases as a distance of the leg away from the base increases.

7. The washing machine of claim 1, wherein
the floating case includes:
a base supporting the magnet, and
a cover covering an upper side of the magnet, and an upper surface of the cover includes an inclined portion extending from an upper end of the cover toward the base and inclined with respect to a horizontal direction.

8. The washing machine of claim 7, wherein the inclined portion includes a conical portion having a horizontal width that decreases as a distance from the upper end of the cover decreases.

9. The washing machine of claim 8, wherein the inclined portion includes a curved portion between the conical portion and the base and having an inclination angle with respect to the horizontal direction that increases as a distance from the base decreases.

10. The washing machine of claim 1, wherein the detergent box includes a guide rib along a periphery of the floating case configured to guide movement in a vertical direction of the floating case in the detergent box.

11. The washing machine of claim 10, wherein the guide rib extends upward from a bottom surface of the detergent box.

12. The washing machine of claim 10, wherein
the guide rib includes a plurality of guide ribs,
the plurality of guide ribs form a movement space in which the floating case is movable in the vertical direction, and
the detergent box further includes a cap covering an upper side of the movement space and coupled to an upper end of each guide rib of the plurality of guide ribs.

13. The washing machine of claim 10, wherein the guide rib includes a support portion protruding from a lower portion of the guide rib and configured so that, with a vertical position of the floating case being at a lowest position in the detergent box, a lower portion of the floating case is supported on the lower portion of the guide rib and the floating case is spaced apart from a bottom surface of the detergent box.

14. The washing machine of claim 1, further comprising:
a detergent detection electrode configured to detect a height of the liquid detergent stored in the detergent box; and
at least one controller electrically connected to the detergent detection electrode and configured to receive the electrical signal from the magnetic field sensor,
wherein the at least one controller is configured to:
based on the height of the liquid detergent detected by the detergent detection electrode being greater than or equal to a predetermined height and a height of the liquid detergent based on the amount of the liquid detergent indicated by the electrical signal received from the magnetic field sensor being less than the predetermined height, determine that the floating case is stuck to the detergent box.

15. The washing machine of claim 14, wherein the at least one controller is further configured to, based on the determination that the floating case is stuck to the detergent box, control the user interface to output information on the floating case being stuck to the detergent box.
